(19) United States
(12) Patent Application Publication
(10) Pub. No.: US 2024/0050943 A1
(43) Pub. Date: Feb. 15, 2024

(54) MULTI-VOLUME MICROCHAMBER-BASED MICROFLUIDIC PLATFORM AND USE THEREOF

(71) Applicant: CORNELL UNIVERSITY, Ithaca, NY (US)

(72) Inventors: Alireza ABBASPOURRAD, Ithaca, NY (US); Morteza AZIZI, Ithaca, NY (US)

(21) Appl. No.: 18/259,105

(22) PCT Filed: Dec. 22, 2021
(86) PCT No.: PCT/US2021/064946

§ 371 Date: Jun. 23, 2023

Related U.S. Application Data
(60) Provisional application No. 63/130,161, filed on Dec. 23, 2020.

(51) Int. Cl. B01L 3/00; G01N 21/64; G01N 21/78

(52) U.S. Cl. CPC B01L 3/502715; G01N 21/6428; G01N 21/78; B01L 2200/16; B01L 2200/0647; B01L 2400/0472; B01L 2200/0694; B01L 2300/12

(57) ABSTRACT

The present disclosure relates to a microfluidic circuit comprising an inlet port; an outlet port; a main channel fluidically connecting the inlet port and the outlet port; and a series of microchambers of differing volumes disposed within the main channel, where each microchamber is individually fluidically connected to the main channel via individual microchamber openings. The present disclosure also relates to a microfluidic device comprising a support layer; a substrate layer disposed on the support layer; and one or more microfluidic circuits of the present disclosure, where the one or more circuits are disposed within the substrate layer. Also disclosed is a method for performing an assay.

This application claims the benefit of U.S. Provisional Patent Application Ser. No. 63/130,161, filed Dec. 23, 2020, which is hereby incorporated by reference in its entirety.

### FIELD

The present disclosure relates to a multi-volume microchamber-based microfluidic platform and use thereof.

### BACKGROUND

The United States Center of Disease Control and Prevention (CDC) has recently reported that over 48 million people get sick from bacterial pathogens annually. Of those patients, more than 128,000 are hospitalized, among which 3,000 were fatal (Courtney et al., “Potentiating Antibiotics in Drug-Resistant Clinical Isolates via Stimuli Activated Superoxide Generation,” Sci. Adv. 3:e1701776 (2017); Boolchandani et al., “Sequencing-Based Methods and Resources to Study Antimicrobial Resistance,” Nat. Rev. Genet. 20:356-370 (2019); Andersson et al. “Mechanisms and Clinical Relevance of Bacterial Heteroresistance,” Nat. Rev. Microbiol. 17:479-496 (2019)). Even worse statistics might be anticipated in developing countries due to poorer hygiene (Boolchandani et al., “Sequencing-Based Methods and Resources to Study Antimicrobial Resistance,” Nat. Rev. Genet. 20:356-370 (2019); Volbers et al., “Interference Disturbance Analysis Enables Single-Cell Level Growth and Mobility Characterization for Rapid Antimicrobial Susceptibility Testing,” Nano Lett. 19:643-651 (2019); Syal et al., “Antimicrobial Susceptibility Test with Plasmonic Imaging and Tracking of Single Bacterial Motions on Nanometer Scale,” ACS Nano 10:845-852 (2016); Reddy et al., “Point-of-Care Sensors for the Management of Sepsis,” Nat. Biomed. Eng. 2:640-648 (2018)). Fighting against pathogenic bacteria is mostly achieved by antimicrobial agents. However, improper use and overconsumption of antibiotics have led to the emergence of drug-resistant bacterial pathogens (Jose et al. “Extinction of Antimicrobial Resistant Pathogens Using Silver Embedded Silica Nanoparticles and an Efflux Pump Blocker,” ACS Appl. Bio Mater. 2:4681-4686 (2019); Santopolo et al. “Ultrafast and Ultrasensitive Naked-Eye Detection of Urease-Positive Bacteria with Plasmonic Nanosensors,” ACS Sens. 4:961-967 (2019)). Therefore, the appropriate selection of an antimicrobial agent and its right dosage-via antibiotic susceptibility testing (“AST”) assays, where the susceptibility of a pathogen is examined against different concentrations of an antibiotic—not only can accelerate the process of treating microbial diseases, but can also prevent the emerging of new antibiotic-resistant pathogens, and help save millions of lives around the globe annually (Boolchandani et al., “Sequencing-Based Methods and Resources to Study Antimicrobial Resistance,” Nat. Rev. Genet. 20:356-370 (2019); Andersson et al., “Mechanisms and Clinical Relevance of Bacterial Heteroresistance,” Nat. Rev. Microbiol. 17:479-496 (2019); Weibel et al., “Microfabrication Meets Microbiology,” Nat. Rev. Microbiol. 5:209-218 (2007)).

There are conventional settings, such as broth microdilution (BMD), Kirby-Bauer disk diffusion, and Etest strip, which can be utilized to perform the AST assays (Volbers et al., “Interference Disturbance Analysis Enables Single-Cell Level Growth and Mobility Characterization for Rapid Antimicrobial Susceptibility Testing,” Nano Lett. 19:643-651 (2019); Wilkins et al., “Standardized Single-Disc Method for Antibiotic Susceptibility Testing of Anaerobic Bacteria,” Antimicrob. Agents Chemother. 1:451-459 (1972); Jorgensen et al., “Antimicrobial Susceptibility Testing: A Review of General Principles and Contemporary Practices,” Clin. Infect. Dis. 49:1749-1755 (2009)). In these assays, the bacterial morphological changes, biochemical secretion, or signal-changes due to the presence of bacterial metabolites using a molecular assay are the means to monitor the efficacy of the targeted antibiotic. However, these conventional assays are highly time-consuming, labor-intensive, and prone to handling error during sample preparations (Volbers et al., “Interference Disturbance Analysis Enables Single-Cell Level Growth and Mobility Characterization for Rapid Antimicrobial Susceptibility Testing,” Nano Lett. 19:643-651 (2019); van Belkum et al., “Innovative and Rapid Antimicrobial Susceptibility Testing Systems,” Nat. Rev. Microbiol. 18:299-311 (2020)). Moreover, they are expensive due to the enormous amounts of expensive antibiotics required for running each test, and less sensitive-low signal-to-noise ratio-due to the bulky volume (hundred microliters to a few milliliters) of reagents especially in BMD technique used in each well (Avesar et al., “Rapid Phenotypic Antimicrobial Susceptibility Testing Using Nanoliter Arrays,” Proc. Natl. Acad. Sci. 114:E5787-E5795 (2017); Yang et al., “All-Electrical Monitoring of Bacterial Antibiotic Susceptibility in a Microfluidic Device,” Proc. Natl. Acad. Sci. 117:10639-10644 (2020)). These are the shortcomings which often push physicians to prescribe broad-spectrum antibiotics empirically—indiscriminately targeting a broad spectrum of both Gram-positive and Gram-negative bacteria, and not a recommended clinical practice due to potential for increased selection of resistant traits—to stop the pathogenicity of infected bacteria and save the lives, especially in emergency and immunocompromised cases where time is limited (Xu et al., “Simultaneous Identification and Antimicrobial Susceptibility Testing of Multiple Uropathogens on a Microfluidic Chip with Paper-Supported Cell Culture Arrays,” Anal. Chem. 88:11593-11600 (2016); Kim et al., “Onchip Phenotypic Investigation of Combinatory Antibiotic Effects by Generating Orthogonal Concentration Gradients,” Lab Chip 19:959-973 (2019)).

Point-of-care settings, based on cutting-edge microfluidics technology, can be alternatively used for drug screening and specifically AST diagnostics in clinical applications (Syal et al., “Antimicrobial Susceptibility Test with Plasmonic Imaging and Tracking of Single Bacterial Motions on Nanometer Scale,” ACS Nano 10:845-852 (2016); Weibel et al., “Microfabrication Meets Microbiology,” Nat. Rev. Microbiol. 5:209-218 (2007); Avesar et al., “Rapid Phenotypic Antimicrobial Susceptibility Testing Using Nanoliter Arrays,” Proc. Natl. Acad. Sci. 114:E5787-E5795 (2017); Michael et al., “A Fidget Spinner for the Point-Of-Care Diagnosis of Urinary Tract Infection,” Nat. Biomed. Eng. 4:591 (2020); Schoepp et al., “Rapid Pathogen-Specific Phenotypic Antibiotic Susceptibility Testing Using Digital LAMP Quantification in Clinical Samples,” Sci. Transl. Med. 9:eaa13693 (2017); Murray et al., “Research Highlights: Microfluidic Analysis of Antimicrobial Susceptibility,” Lab Chip 15:1226-1229 (2015); Azizi et al., “Nanoliter-Sized Microchamber/Microarray Microfluidic Platform for Antibiotic Susceptibility Testing,” Anal. Chem. 90:14137-14144 (2018); Baltekin et al., “Antibiotic Susceptibility Testing in Less Than 30 Min Using Direct Single Cell Imaging,” Proc. Natl. Acad. Sci. 114:9170-9175 (2017); Gao et al., “A Simple, Inexpensive, and Rapid Method to Assess Antibiotic Effectiveness Against Exoelectrogenic Bacteria,” Biosens. Bioelectron. 168:112518 (2020); Guan et al., “Medical Devices on Chips,” Nat. Biomed. Eng. 1:0045 (2017); Schuster et al., “Automated Microfluidic Platform for Dynamic and Combinatorial Drug Screening of Tumor Organoids,” Nat. Commun. 11:5271 (2020); Eduati et al., “A Microfluidics Platform for Combinatorial Drug Screening on Cancer Biopsies,” Nat. Commun. 9:2434 (2018); Zhu et al., “High-Throughput Antimicrobial Susceptibility Testing and Antibiotics Screening,” Angew. Chem. Int. Ed. 50:9607-9610 (2011); Schoepp et al., “Digital Quantification of DNA Replication and Chromosome Segregation Enables Determination of Antimicrobial Susceptibility After Only 15 Minutes of Antibiotic Exposure,” Angew. Chem. Int. Ed. 55:9557-9561 (2016); Boehle et al., “Utilizing Paper-Based Devices for Antimicrobial-Resistant Bacteria Detection,” Angew. Chem. Int. Ed. 56:6886-6890 (2017); Safavieh et al., “Rapid Real-Time Antimicrobial Susceptibility Testing with Electrical Sensing on Plastic Microchips with Printed Electrodes,” ACS Appl. Mater. Interfaces 9:12832-12840 (2017); Liao et al., “Multichannel Dynamic Interfacial Printing: An Alternative Multicomponent Droplet Generation Technique for Lab in a Drop,” ACS Appl. Mater. Interfaces 9:43545-43552 (2017). There are different microfluidics platforms, such as digital droplet microfluidics, agarose microchannels, electrokinetics, and microfluidic confinement, etc., which have been developed for AST (Avesar et al., “Rapid Phenotypic Antimicrobial Susceptibility Testing Using Nanoliter Arrays,” Proc. Natl. Acad Sci. 114:E5787-E5795 (2017); Yang et al., “All-Electrical Monitoring of Bacterial Antibiotic Susceptibility in a Microfluidic Device,” Proc. Natl. Acad Sci. 117:10639-10644 (2020); Azizi et al., “Nanoliter-Sized Microchamber/Microarray Microfluidic Platform for Antibiotic Susceptibility Testing,” Anal. Chem. 90:14137-14144 (2018); Baltekin et al., “Antibiotic Susceptibility Testing in Less Than 30 Min Using Direct Single Cell Imaging,” Proc. Natl. Acad Sci. 114:9170-9175 (2017); Wang et al., “cAST: Capillary-Based Platform for Real-Time Phenotypic Antimicrobial Susceptibility Testing,” Anal. Chem. 92:2731-2738 (2020); Li et al., “Adaptable Microfluidic System for Single-Cell Pathogen Classification and Antimicrobial Susceptibility Testing,” Proc. Natl. Acad Sci. 116:10270-10279 (2019); Rao et al., “Rapid Electrochemical Monitoring of Bacterial Respiration for Gram-Positive and Gram-Negative Microbes: Potential Application in Antimicrobial Susceptibility Testing,” Anal. Chem. 92:4266-4274 (2020); Svensson et al., “Coding of Experimental Conditions in Microfluidic Droplet Assays Using Colored Beads and Machine Learning Supported Image Analysis,” Small 15:1802384 (2019); Zhang et al., “Microfluidic Systems for Rapid Antibiotic Susceptibility Tests (ASTs) at the Single-Cell Level,” Chem. Sci. 11:6352 (2020); Zhang et al., “MALDI-TOF Characterization of Protein Expression Mutation During Morphological Changes of Bacteria Under the Impact of Antibiotics,” Anal. Chem. 91:2352-2359 (2019); Spencer et al., “A Fast Impedance-Based Antimicrobial Susceptibility Test,” Nat. Commun. 11:5328 (2020)). Despite impressive advancements in developing such devices (Svensson et al., “Coding of Experimental Conditions in Microfluidic Droplet Assays Using Colored Beads and Machine Learning Supported Image Analysis,” Small 15:1802384 (2019); Hong et al., “Antibiotic Susceptibility Determination within One Cell Cycle at Single-Bacterium Level by Stimulated Raman Metabolic Imaging,” Anal. Chem. 90:3737-3743 (2018)), there has always been a trade-off between their simplicity (implementation), throughput, assay time, instrumentation, etc., which has avoided using them as a ready-to-use platform in clinical applications (Yang et al., “All-Electrical Monitoring of Bacterial Antibiotic Susceptibility in a Microfluidic Device,” Proc. Natl. Acad Sci. 117:10639-10644 (2020); Baltekin et al., “Antibiotic Susceptibility Testing in Less Than 30 Min Using Direct Single Cell Imaging,” Proc. Natl. Acad Sci. 114:9170-9175 (2017); Rao et al., “Rapid Electrochemical Monitoring of Bacterial Respiration for Gram-Positive and Gram-Negative Microbes: Potential Application in Antimicrobial Susceptibility Testing,” Anal. Chem. 92:4266-4274 (2020); Spencer et al., “A Fast Impedance-Based Antimicrobial Susceptibility Test,” Nat. Commun. 11:5328 (2020); Kong et al., “Adhesive Tape Microfluidics with an Autofocusing Module That Incorporates CRISPR Interference: Applications to Long-Term Bacterial Antibiotic Studies,” ACS Sens. 4:2638-2645 (2019)). For example, one common issue with these devices is the lack of their throughput as mostly one single antibiotic concentration is tested on a bacterial suspension in a given test (Yang et al., “All-Electrical Monitoring of Bacterial Antibiotic Susceptibility in a Microfluidic Device,” Proc. Natl. Acad. Sci. 117:10639-10644 (2020); Baltekin et al., “Antibiotic Susceptibility Testing in Less Than 30 Min Using Direct Single Cell Imaging,” Proc. Natl. Acad. Sci. 114:9170-9175 (2017); Li et al., “Adaptable Microfluidic System for Single-Cell Pathogen Classification and Antimicrobial Susceptibility Testing,” Proc. Natl. Acad. Sci. 116:10270-10279 (2019); Spencer et al., “A Fast Impedance-Based Antimicrobial Susceptibility Test,” Nat. Commun. 11:5328 (2020)). While a complete AST assay should be performed over a wide range of antibiotic concentrations (such as 2-3 order of magnitudes) to robustly predict the susceptibility/resistance outcome along with the minimum inhibitory concentration (MIC) for a susceptibility outcome.

Fast determination of antimicrobial agents' effectiveness (susceptibility/resistance pattern) is an essential diagnostics step for treating bacterial infections and stopping their associated world-wide outbreaks. There is a need to produce a robust antibiotic gradient-based concentration profile that functions in a high-throughput mode in order to meet this need.

The present disclosure is directed to overcoming these and other deficiencies in the art.

### SUMMARY

One aspect of the present disclosure relates to a microfluidic circuit comprising an inlet port; an outlet port; a main channel fluidically connecting the inlet port and the outlet port; and a series of microchambers of differing volumes disposed within the main channel, where each microchamber is individually fluidically connected to the main channel via individual microchamber openings.

Another aspect of the present disclosure relates to a microfluidic device comprising a support layer; a substrate layer disposed on the support layer; and one or more microfluidic circuits of the present disclosure, where the one or more circuits are disposed within the substrate layer.

A further aspect of the present disclosure relates to a method for performing an assay. This method involves loading a first reagent solution into the inlet port of a microfluidic device of the present disclosure; loading a second reagent solution into the inlet port; loading an isolating solution into the outlet port; and detecting an interaction between the first reagent solution and the second reagent solution in one or more of the microchambers.

The present disclosure relates to an egg-like multi-volume microchamber-based microfluidic (referred to herein as “EL-MVM²”) platform (also referred to herein as a device) designed to perform, e.g., antibiotic susceptibility testing in a high-throughput manner. In one example of the use of the platform, a bacterial suspension is loaded into designed multi-volume microchambers in the EL-MVM² platform and exposed with antibiotic solution. Upon loading the same amount of antibiotic into pre-bacteria-loaded multi-volume microchambers and isolating them with a biocompatible oil, a gradient pattern of a test antibiotic is precisely made inside the microchambers. Using resazurin-based molecular assay through the fluorescent signal-changes of culture medium, the bacterial metabolic responses to a wide range of antibiotic concentrations is recorded. The EL-MVM² platform is easy to implement and can produce an antibiotic concentration range within a short period of time (˜10 min). No complicated training is required for the running of this platform, as the loading time is the only parameter needed to be controlled by an operator. Moreover, unlike conventional methods which can require several hundred microliters to a few milliliters of a costly antibiotic to produce just one antibiotic concentration for testing, the complete AST assay using the EL-MVM² platform is performed using a small-amount of the targeted antibiotic (˜20 μL).

The microfluidic-based EL-MVM² platform showed an excellent potential for AST assays within a short period of time (<4 h). This platform enabled the production of an unprecedented concentration range of antimicrobial agents to be evaluated in a single test. These antibiotic concentrations were produced in microchambers in the EL-MVM² platform, and made it possible to perform a complete AST test using only a few microliters of expensive antimicrobial agents, a cost effective system compared to conventional methods, which require hundreds of microliters to milliliters for a complete test. In addition, performing assays in this platform required only a minimal operation procedure to produce the antibiotic concentrations, which helps prevent human random error. Specifically, the only parameter needed to be controlled by the operator is the antibiotic loading time. Moreover, the antibiotic concentration preparation into microchambers is a function of defined microchamber volume during the antibiotic loading, highlighting how robust antibiotic gradient concentration profiles (GCPs) can be produced.

The microfluidic-based EL-MVM² platform was used for AST assays and its performance was comparable to the more labor intensive and expensive conventional BMD technique. The EL-MVM² platform showed an excellent performance as it predicted the susceptibility/resistance outcomes with close MIC values for more than 97% of the performed tests (even more than 95% accuracy criterion for FDA approval of technology-based AST instruments).

### BRIEF DESCRIPTION OF THE DRAWINGS

FIG. 1 is a top view of one embodiment of a microfluidic circuit of the present disclosure comprising an inlet port; an outlet port; a main channel fluidically connecting the inlet port and the outlet port; and a series of microchambers of differing volumes disposed within the main channel, where each microchamber is individually fluidically connected to the main channel via individual microchamber openings.

FIG. 2 is a perspective, cut-away view of one embodiment of a microfluidic device of the present disclosure comprising a microfluidic circuit of the present disclosure disposed within the substrate layer of the microfluidic device.

FIG. 3 is an amplified view of section 3 of the microfluidic circuit shown in the microfluidic device of FIG. 2.

FIG. 4 is a top view of a microfluidic device of the present disclosure with the top portion of the substrate completely cut away to show the underlying microfluidic circuits formed in the substrate. The microfluidic device shown comprises three microfluidic circuits for performing an assay with high, intermediate, and low concentrations of a test reagent.

FIGS. 5A-D relate to the EL-MVM² platform principles and operation. FIG. 5A is an illustration of the features of one embodiment of the EL-MVM² platform from the perspective view. The inset figure shows a microchamber embedded inside the main-channel.

FIG. 5B is an illustration that depicts the top view of the EL-MVM² platform, demonstrating the producing antibiotic GCPs in microchambers. FIG. 5C shows an illustration and photographs relating the concept behind the naming of the EL-MVM² platform, as microchambers resemble an egg, having two parts: the egg white (the PDMS wall of microchambers) and the egg yolk (the bacterial-drug suspension loaded and thermally incubated). Bright-field and fluorescent images show a microchamber loading with GFP-labeled bacteria and incubated within 4-h thermal incubation to elaborate the egg-like concept behind the EL-MVM² platform naming. FIG. 5D is an illustration showing the protocol for sample and drug loading in the EL-MVM² platform including four major steps: Step-i: Bacterial suspension loading; Step-ii: Antibiotic loading; Step-iii: Oil washing step to discharge the excess antibiotic solution from the main-channel; and Step-iv: Drug homogenous distribution into microchambers.

FIGS. 6A-H relate to the characterization of the EL-MVM² platform for resazurin as a fluorescent dye. FIG. 6A is a photograph showing fluorescent images of microchambers M-D₁ and M-D₉ representing the experimental resazurin loading within 160 s and 240 s for microchambers M-D₁ and M-D₉, respectively. FIG. 6B is an illustration of the CFD-simulations-derived images of resazurin diffusion into two microchambers M-D₁ and M-D₉ within 160 s and 240 s. FIG. 6C and FIG. 6D show graphs of the experimental (FIG. 6C) and CFD-simulation-based resazurin concentration profiles (FIG. 6D) for two microchambers M-D₁ and M-D₉ within 160 s (experimentally-obtained) and 240 s (CFD-simulation-obtained) time-period. FIG. 6E is an illustration and photographic images (obtained using experiments) of microchambers M-D₁ and M-D₉ to demonstrate the lack of flow streamlines in microchambers, confirming the resazurin (in a broader aspect, antibiotics) diffusion is the main mechanism for mass-transport into microchambers. FIG. 6F is a graph showing time-lapse resazurin concentration profiles into microchamber M-D₁ and the time-lapse resazurin concentration ratio in microchambers (M-D₁/M-D₉) for finding the maximum concentration difference between microchambers M-D₁ and M-D₉ in each low, intermediate, and high concentration subcategories. FIG. 6G is a photographic compilation of fluorescent images of M-D₁-M-D₉ microchambers obtained using loading resazurin at its optimal time-point (t=175 s), previously founded in FIG. 6F, to obtain a resazurin GCP. FIG. 6H is a graph of the average gray-values (n=5) of the microchambers M-D₁-M-D₉, obtained through converting the fluorescent intensities to gray-values for each microchamber.

FIGS. 7A-E relate to EL-MVM² platform reproducibility. FIG. 7A is an illustration of the concentration profiles for drugs with different diffusion coefficients obtained into the microchambers M-D₁-M-D₉ using CFD simulations. The loading time was set the same as 300 s for all diffusion coefficients. FIG. 7B is an illustration and graph of the qualitative and quantitative concentration profiles for drugs with diffusion coefficients 1×10⁻¹⁰, 1×10⁻⁹, and 1×10⁻⁸ m²/s while the loading times were adjusted to obtain the same GCPs. The data showed that loading time and diffusion coefficients have inverse linear relationship with GCP, as GCP∝Fun. (D/molar volume). FIG. 7C is a compilation of time-lapse fluorescent photographic images, showing the loading kinetics of fluorescein into the microchamber M-D₁. FIG. 7D is a graph of the normalized concentration profiles over the length L of the microchamber M-D₁ (equals to its diameter) for resazurin, fluorescein, and calcein. FIG. 7E shows a linear correlation between the loading time and molar volume of resazurin, fluorescein, and calcein (loading time∝1/molar volume or GCP∝Fun. (D/molar volume)). FIG. 7F is a graph of resazurin, fluorescein, and calcein GCPs in EL-MVM² platform plotted together. The loading times obtained in the graph of FIG. 7E were used for this experiment.

FIGS. 8A-F relate to the timescales for antibiotics' homogenous distribution in microchambers in one embodiment of the EL-MVM² platform. FIG. 8A is an illustration of the concentration pattern of resazurin distribution into microchambers M-D₁ and M-D₉ over the distribution time obtained using CFD simulations. FIG. 8B is a graph of normalized resazurin concentration (Cᵢ/C₀) profiles for microchambers M-D₁ and M-D₉ over the distribution time. FIG. 8C is a graph of resazurin homogenous distribution time for microchambers M-D₁-M-D₉ and comparing its trend with the squared M-D₁-based normalized volume of microchambers (V_{M-Di}/V_{M-D1})². FIGS. 8D-8F are illustrations of concentration patterns of three representative drugs with diffusion coefficients D=1.0×10⁻⁹ (FIG. 8D), 5.0×10⁻¹⁰ (FIG. 8E), and 1.66×10⁻¹⁰ m²/s (FIG. 8F), obtained using CFD simulations. They represent, for example, three azacitidine, dicloxacillin, and actinomycin D antibiotic drugs, respectively, to compare the antibiotic homogenous distribution in microchambers M-D₁-M-D₉ of the EL-MVM² platform.

FIGS. 9A-E relate to EL-MVM² functionality for an AST assay. FIG. 9A is a compilation of photographic fluorescent images of microchambers M-D₁-M-D₉ in low, intermediate, and high concentration ranges showing the resazurin reduction due to the E. coli 541-15 bacterial growth in the presence of different concentrations of gentamicin at t=0 h and t=4.5 h. FIG. 9B is a compilation of photographic green fluorescent images of microchambers M-D₁-M-D₉ in low, intermediate, and high concentration ranges demonstrating the GFP-labeled E. coli 541-15 bacterial growth at t=0 h and t=4.5 h in the presence of different concentrations of gentamicin at t=0 h and t=4.5 h. FIG. 9C is a graph of gray-values for M-D₁-M-D₉ microchambers at t=0 h and t=4.5 h. FIG. 9D is a graph of the optical density (OD₆₀₀) changes versus E. coli 541-15 bacterial growth time at different concentrations of gentamicin, obtained using the BMD test. FIG. 9E is a graph showing MIC data-points obtained using the EL-MVM² platform and gold standard broth microdilution technique (n=9) for comparison between these two techniques.

FIGS. 10A-B relate to EL-MVM² performance for bacterial clinical isolates. FIG. 10A is a chart of nalidixic acid, streptomycin, chloramphenicol, and ampicillin tested on a clinical bacterial isolate (E. coli 541-15) and the interpretation of the data. FIG. 10B is a chart of gentamicin, nalidixic acid, streptomycin, chloramphenicol, and ampicillin tested versus five clinical bacterial isolates (E. coli LF82, Enterococcus faecalis, Enterococcus faecium, Klebsiella pneumoniae, and Klebsiella spp.).

FIG. 11 is an illustration of the sizes and naming used for the EL-MVM² microchambers.

FIG. 12 is a photograph of the EL-MVM² device before and after use. A dark blue dye was used to visualize the different aspects of the EL-MVM² device.

FIG. 13 is an illustration of CFD simulations for M-D₁-M-D₃ (top panel) and M-D₈-M-D₉ (bottom panel) as they represent the streamlines formed outside the microchambers' area and no streamlines inside the microchambers. This indicates that drug diffusion into microchambers is the main mechanism for drug loading into microchambers.

FIG. 14 is a graph showing the time-lapse resazurin concentration profiles into microchamber M-D₁ and the time-lapse resazurin concentration ratio in microchambers (M-D₁/M-D₉) for finding the maximum concentration difference between microchambers M-D₁ and M-D₉ in each low, intermediate, and high concentration subcategories.

FIGS. 15A-B relate to the loading kinetics of calcein into the microchamber M-D₁. FIG. 15A is a photograph of time-lapse fluorescent images, showing the loading kinetics of calcein into the microchamber M-D₁. FIG. 15B is a graph showing normalized concentration profiles over the length L of the microchamber M-D₁ (equal to its diameter) for calcein.

FIG. 16 is a graph showing loading times for a wide range of commercial antibiotics used in clinical diagnostics.

### DETAILED DESCRIPTION

The present disclosure relates to a multi-volume microchamber-based microfluidic platform and use thereof.

Unless otherwise indicated, the definitions and embodiments described in this and other sections are intended to be applicable to all embodiments and aspects of the present application herein described for which they are suitable as would be understood by a person skilled in the art.

Singular forms “a”, “an”, and “the” include plural references unless the context clearly dictates otherwise. Thus, for example, a reference to “a method” includes one or more methods, and/or steps of the type described herein and/or which will become apparent to those persons skilled in the art upon reading this disclosure. In another example, reference to “a compound” includes both a single compound and a plurality of different compounds.

The term “about” includes being within a statistically meaningful range of a value. Such a range can be within an order of magnitude, preferably within 50%, more preferably within 20%, still more preferably within 10%, and even more preferably within 5% of a given value or range. The allowable variation encompassed by the term “about” depends on the particular system under study, and can be readily appreciated by one of ordinary skill in the art.

The term “and/or” as used herein means that the listed items are present, or used, individually or in combination. In effect, this term means that “at least one of” or “one or more” of the listed items is used or present.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “involving”, “having”, and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps. In embodiments or claims where the term comprising (or the like) is used as the transition phrase, such embodiments can also be envisioned with replacement of the term “comprising” with the terms “consisting of” or “consisting essentially of.” The methods, kits, systems, and/or compositions of the present disclosure can comprise, consist essentially of, or consist of, the components disclosed.

Certain terms employed in the specification, examples, and claims are collected herein. Unless defined otherwise, all technical and scientific terms used in this disclosure have the same meanings as commonly understood by one of ordinary skill in the art to which this disclosure belongs.

Preferences and options for a given aspect, feature, embodiment, or parameter of the disclosure should, unless the context indicates otherwise, be regarded as having been disclosed in combination with any and all preferences and options for all other aspects, features, embodiments, and parameters of the disclosure.

One aspect of the present disclosure relates to a microfluidic circuit comprising an inlet port; an outlet port; a main channel fluidically connecting the inlet port and the outlet port; and a series of microchambers of differing volumes disposed within the main channel, where each microchamber is individually fluidically connected to the main channel via individual microchamber openings.

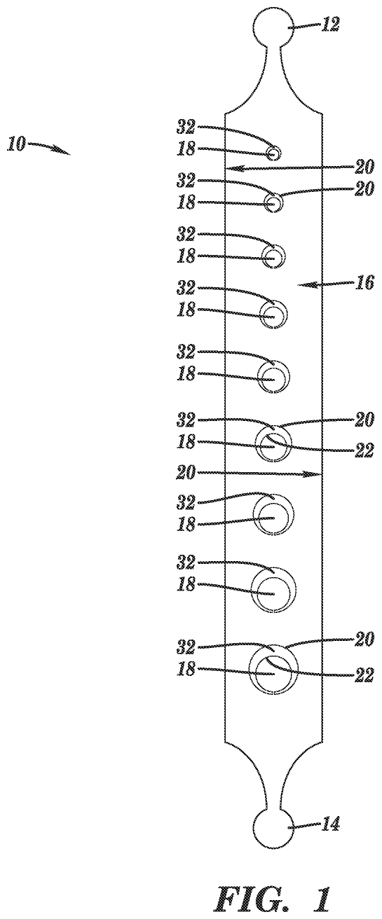

One embodiment of a microfluidic circuit of the present disclosure is illustrated in FIG. 1. FIG. 1 shows a top view of one embodiment of a microfluidic circuit of the present disclosure. Specifically, microfluidic circuit 10 comprises inlet port 12, outlet port 14, and main channel 16. Main channel 16 is fluidically connected to inlet port 12 and outlet port 14 such that fluid may enter inlet port 12, travel through main channel 16, and arrive at outlet port 14.

Microfluidic circuit 10 also has a series of microchambers of differing volumes, shown in FIG. 1 as microchambers 18 disposed within main channel 16. Each microchamber 18 is individually fluidically connected to main channel 16 via individual microchamber openings (illustrated in FIG. 3 as opening 152). In some embodiments, the microchambers 18 comprise a linear arrangement in the main channel 16. As illustrated in FIG. 1, the series of microchambers 18 have differing volumes (smaller to larger from inlet port 12 toward outlet port 14), which permit the creation of a concentration gradient of fluids, as discussed in more detail below. In some embodiments, the microfluidic circuit comprises microchambers of differing volumes, but their positioning within the main channel may not follow an incremental increase (or decrease) in size as illustrated in FIG. 1, and their arrangement is not necessarily linear. There may be advantages to a linear organization, see FIG. 13.

In the embodiment illustrated in FIG. 1, main channel 16 has a linear shape, although main channel 16 may take on other shapes depending on particular application or use of microfluidic circuit 10. In some embodiments, the main channel comprises a linear shape. Main channel 16 is defined by inner wall 20 around the perimeter of microfluidic circuit 10 and around each of microchambers 18 to define each microchamber 18. While inner wall 20 defines the exterior perimeter of each of microchamber 18, the interior cavity of each microchamber 18 is defined by an interior wall 22 of substrate 32.

The size of each of the component parts of the microfluidic circuit of the present disclosure may vary according to particular application or use. For example, and without limitation, in some embodiments, each inner wall of the microchambers may have a diameter of between about 200-1500 μm, or 400-1400 μm, or 400, 490, 564, 632, 692, 774, 1000, 1183 and/or 1400 μm, or any particular dimension or range of dimensions therein. In some embodiments, the inner wall of the microchambers may have a diameter larger than 1400 μm. Individual microchamber openings 152 (FIG. 3) may have an opening width of about 40-100 μm, or 60-80 μm, or 70 μm, or any particular dimension or range of dimensions therein. The inlet port may comprise a diameter of about 500-1500 μm. The outlet port may comprises a diameter of about 500-1500 μm. The inlet and outlet ports may be different sizes, and may be larger than 1500 μm, or smaller than 500 μm. In some embodiments, the individual microchamber openings are positioned to face the outlet port(s). In some embodiments, the individual microchamber openings are positioned to face the inlet port(s).

As illustrated in FIG. 1, microfluidic circuit 10 comprises nine microchambers 18. However, the microfluidic circuit of the present disclosure may comprise any number of microchambers and, in some embodiments, comprises 2, 3, 4, 5, 6, 7, 8, 9, 10, 11, 12, 13, 14, 15, 16, 17, 18, 19, 20, 21, 22, 23, 24 or more than 24 microchambers. In some embodiments, the microfluidic circuit comprises 9 microchambers. In some embodiments, the microfluidic circuit comprises 5-10 microchambers. In the microfluidic circuit of the present disclosure, microchambers have differing fluidic volumes so as to create a gradient of test volumes to carry out test comparisons. As discussed in more detail below, each microchamber may be filled with a biological substance and then an equal amount of test substance (also called a reagent solution) transports or diffuses into each of the series of microchambers to create a concentration gradient determined by the size of each microchamber.

In the embodiment illustrated in FIG. 1, microchambers 18 of microfluidic circuit 10 comprise a circular shape and the diameter of each microchamber 18 increases as its position increases in distance from inlet port 12. According to this embodiment, microchambers 18 closer to inlet port 12 have the smallest diameter and hold the smallest volume of fluid and the size and volume of microchambers 18 increase according to their position moving away from inlet port 12 toward outlet port 14. As discussed in greater detail below, substances tested in microchambers 18 nearest inlet port 12 will have a greater concentration of test substance than microchambers 18 positioned further from inlet port 12 and the microchamber furthest from inlet port 12 and closest to outlet port 14 (i.e., microchamber 18 with the largest size and volume) will create a test chamber with the lowest concentration of a test substance. In other words, in the particular embodiment illustrated in FIG. 1, microchambers 18 are arranged in size of graduated volumes from lowest to highest from inlet port 12 towards outlet port 14. Other size and volume arrangements of the microchambers may also be used, including a gradient in the opposite direction (i.e., where the microchamber of the highest volume capacity is nearest the inlet port and the microchamber of the lowest capacity is nearest the outlet port), or no linear gradient at all (i.e., just an assortment of microchambers with differing volumes).

The microfluidic circuit of the present disclosure pertains to a fluidic system of ports, channels, and microchambers, all fluidically connected. Since, as discussed in the Examples below, the particular structure of this fluidically connected system enables assays to be performed based on the unique structure of the circuit, the circuit may be used in a variety of contexts or on a variety of platforms. One particular platform where the microfluidic circuit of the present disclosure is useful is a chip-like platform. For example, the microfluidic circuit may be formed into a planar material to create the system of ports, channels, and microchambers, accessible for input or output of fluid only through the ports.

Thus, another aspect of the present disclosure relates to a microfluidic device comprising a support layer; a substrate layer disposed on the support layer; and one or more microfluidic circuits of the present disclosure, where the one or more circuits are disposed within the substrate layer.

In some embodiments, the microfluidic device of the present disclosure includes an aggregation of separate parts, for example, but not limited to, ports, fluid channels, capillaries, joints, chambers, and layers which, when contiguous or appropriately mated or joined together, form the microfluidic device of the present disclosure. In some embodiments, the microfluidic device may include a top portion, a bottom portion, and an interior portion, one or more of which substantially defines ports, channels, and chambers of the microfluidic device.

In some embodiments, the bottom portion may be a solid support or a substrate that is substantially planar in structure, and which has a substantially flat upper surface. A variety of materials may be used to form the solid support and/or a substrate, which itself is formed on or connected to the solid support. The support and/or substrate materials should be selected based upon their compatibility with known microfabrication techniques, for example, photolithography, 3-D printing, wet chemical etching, laser ablation, air abrasion techniques, injection molding, embossing, and other techniques, or based on the application being used. The support and/or substrate materials are also generally selected for their compatibility with the full range of conditions to which the microfluidic devices may be exposed, including extremes of pH, temperature, salt concentration, and/or application of electric fields, should these be relevant in performing assays using the microfluidic device of the present disclosure.

In some embodiments, suitable support and/or substrate materials include, without limitation, glass, pyrex, glass ceramic, polymer materials, semiconductor materials, and combinations thereof. In some embodiments, the support and/or substrate material may include materials normally associated with the semiconductor industry in which microfabrication techniques are regularly employed, including, e.g., silica based substrates such as glass, quartz, silicon, or polysilicon, as well as other substrate materials, such as gallium arsenide and the like. In the case of semiconductive materials, it will often be desirable to provide an insulating coating or layer, e.g., silicon oxide or silicon nitride, over the support or substrate material, particularly where electric fields are to be applied. In some embodiments, the support layer comprises glass.

Exemplary polymeric materials include, without limitation, plastics such as polymethylmethacrylate (PMMA), polycarbonate, polytetrafluoroethylene (TEFLON™), polyvinylchloride (PVC), polydimethylsiloxane (PDMS), and polysulfone. Other plastics can also be used. Such materials are readily manufactured from microfabricated masters, using well known molding techniques, such as injection molding, embossing or stamping, or by polymerizing the polymeric precursor material within a mold. Such polymeric substrate materials are known for their ease of manufacture, low cost and disposability, as well as their general inertness to most extreme reaction conditions. These polymeric materials may include treated surfaces, for example, derivatized or coated surfaces, to enhance their utility in the microfluidic device or, for example, to provide enhanced fluid direction should that be a needed factor in carrying out assays using microfluidic devices described herein. In some embodiments, the substrate layer comprises PDMS. PDMS is also gas permeable, which allows air to escape into the PDMS substrate from the microchambers during loading of solutions so that the microchambers can be completely filled.

In some embodiments, the material used to build the interior portion, which may at least partially define the microfluidic circuit, is biocompatible and resistant to biofouling. Because the active surface area of the microfluidic device may be only a few μm², the material used to form the interior portion (i.e., the microfluidic circuit) should have a resolution that enables the structuring of both small cross-sectional area channels (on the order of about 2-3 μm width and about 1-2 μm height) and larger cross-sectional area channels (on the order of about 25 to about 500 μm width and/or height, or other dimensions described herein). Several existing materials, widely used for the fabrication of microfluidic circuits, can address these basic needs.

Two categories can be distinguished among them: those based on glasses, such as glass, Pyrex, quartz, etc. (Ymeti et al., Biosens. Bioelectron 20:1417-1421 (2005), which is hereby incorporated by reference in its entirety); and those based on polymers such as polyimide, photoresist, SU-8 negative photoresist, polydimethylsiloxane (PDMS), 3-D printing, silicone elastomer PDMS (McDonald et al., Electrophoresis 21:27-40 (2000), which is hereby incorporated by reference in its entirety), liquid crystal polymer, Teflon, etc.

While glass materials have good chemical and mechanical resiliency, their high cost and delicate processing make them less frequently used for this kind of application. In contrast, polymers have gained wide acceptance as the materials of choice for fluidics (including microfluidics) applications. Moreover, structuring technologies involved in their use, such as bonding, molding, embossing, melt processing, and imprinting technologies, are now well developed (Mijatovic et al., Lab on a Chip 5:492-500 (2005), which is hereby incorporated by reference in its entirety). An additional advantage of polymer-based microfluidic systems is that valves and pumps made with the same material may be readily integrated (Unger et al., Science 288:113-116 (2000), which is hereby incorporated by reference in its entirety).

PDMS and SU-8 resist are particularly well studied as raw materials for the construction of microfluidic systems. While both of them are optically transparent, their mechanical and chemical comportment are strongly disparate. SU-8 is stiffer (Blanco et al., J Micromechanics Microengineering 16:1006-1016 (2006), which is hereby incorporated by reference in its entirety) than PDMS, and so the structuring techniques of these two materials are different. Their chemical properties are an important aspect for the desired application. They both have a hydrophobic surface after polymerization, which can lead to an attachment of the proteins onto the PDMS walls, and can fill the channel in case of small cross-section. Both the surface of PDMS and of SU-8 can be treated with a surfactant or by plasma to become hydrophilic (Nordstrom et al., J Micromechanics Microengineering 14:1614-1617 (2004), which is hereby incorporated by reference in its entirety). The composition of SU-8 can also be modified before its structuring to become hydrophilic after polymerization (Chen and Lee, J Micromechanics Microengineering 17:1978-1984 (2007), which is hereby incorporated by reference in its entirety). Fouling of the channel surface via nonspecific binding is an obvious concern for any microfluidic application. Anecdotal evidence suggests that SU-8 is less prone to this, but it is important to note that chemical treatment methods are also available for improving the performance of PDMS (Lee and Vörös, Langmuir 21:11957-11962 (2004), which is hereby incorporated by reference in its entirety). PDMS is also gas permeable, which allows air to escape into the PDMS substrate from the microchambers during loading of solutions so that the microchambers can be completely filled.

Support and/or substrate materials can also be a combination of a glass or Pyrex base and a polymer lid, which together define the microfluidic circuit. In some embodiments, the microfluidic circuit(s) of the microfluidic device of the present disclosure is fabricated as a mold on a silicon wafer to which a layer of PDMS substrate or other material, without limitation, is applied to form the microfluidic device. The PDMS substrate is then peeled off the mold, and applied to a support material, such as glass, and treated to seal the microfluidic circuit(s), as further described herein, and in the Examples. In some embodiments, the “ceiling” of the microfluidic circuit is formed of the contiguous substrate layer, such as when the PDMS material is poured on a silicon wafer mold. In some embodiments, the microfluidic device is fabricated as microscale grooves or indentations formed into the upper surface of the substrate or bottom surface of the polymer lid using microfabrication techniques. In some embodiments, the lower surface of the top portion (also referred to as top layer) of the microfluidic device, which top portion comprises a second planar substrate, can be overlaid upon and bonded to the surface of the bottom support or substrate, sealing the channels and/or chambers (the microfluidic circuit) of the device at the interface of these two components. Bonding of portions to form a microfluidic device comprising a microfluidic circuit may be carried out using a variety of known methods, depending upon the nature of the support and/or substrate material. For example, in the case of glass supports/substrates, thermal bonding or plasma bonding techniques may be used which employ elevated temperatures and pressure to bond one portion of the device to another portion (e.g., a top portion to a bottom portion). Polymeric substrates may be bonded using similar techniques, except that the temperatures used are generally lower to prevent excessive melting of the substrate material. Alternative methods may also be used to bond polymeric parts of the device together, including acoustic welding techniques, or the use of adhesives, for example, UV curable adhesives.

Like the microfluidic circuit, the microfluidic device of the present disclosure is not limited in its physical dimensions and may have any dimensions that are convenient for a particular application. For the sake of compatibility with current laboratory apparatus, microfluidic devices with external sizes of a standard microscope slide or smaller can be easily made. Other microfluidic devices can be sized such that the device fits a standard size used on an instrument, for example, the sample chamber of a mass spectrometer or the sample chamber of an incubator. The microfluidic circuit within the microfluidic device may have any shape, without limitation, such as rectangular, square, oval, circular, or polygonal. The microfluidic circuit, and/or the microchambers and channels that make the microfluidic circuit in the microfluidic device may have square or round bottoms, V-shaped bottoms, flat bottoms, or U-shaped bottoms, without limitation. The shape of the chamber and/or channel bottoms need not be uniform on a particular chip, but may vary. The chambers in the microfluidic device of the present disclosure may have any width-to-depth ratio, which may vary from chamber to chamber. The microchambers wells and channels, and other associated features in the microfluidic device of the present invention may have any volume or diameter which is compatible with the requirements of the sample volume being used. The microchambers or channels can function as a reservoir, a mixer, or a place where chemical or biological reactions take place. In some embodiments, the biological reactions take place in the microchambers.

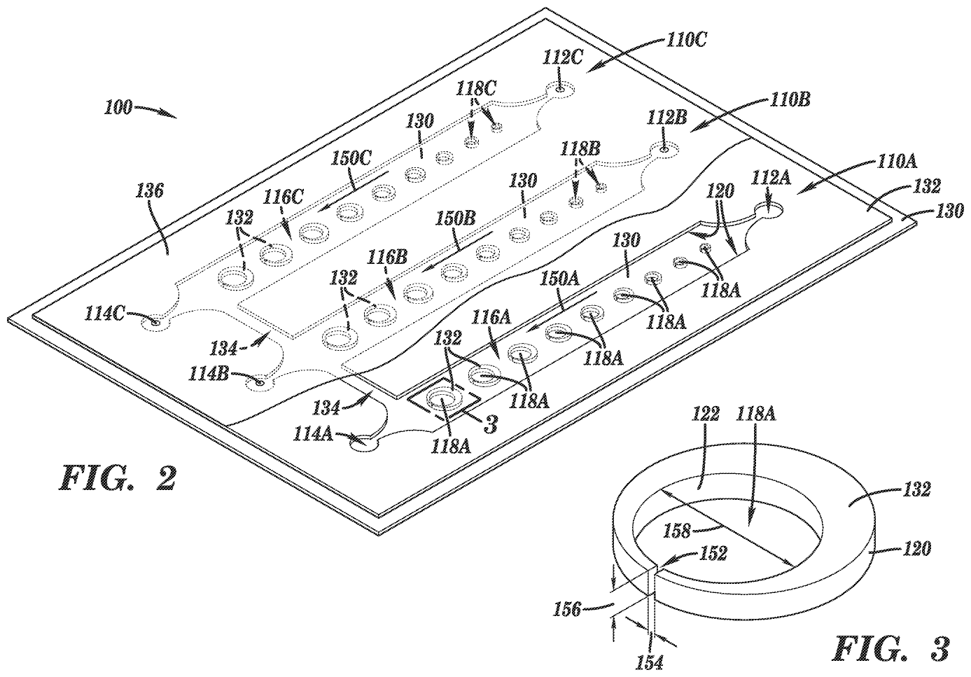

One embodiment of a microfluidic device of the present disclosure is illustrated in FIG. 2. FIG. 2 is a perspective and partial cutaway view of one embodiment of a microfluidic device of the present disclosure. As illustrated, microfluidic device 100 comprises support layer 130. In some embodiments of the microfluidic device of the present disclosure, support layer 130 is a glass slide, although other materials may also be used to support the microfluidic device as discussed above. In some embodiments, the support layer is a planar surface, although non-planar surfaces with added features may also be used as a support layer. In some embodiments, support layer 130 is a non-porous surface. In some embodiments, support layer 130 has some porosity. In some embodiments, the support layer may have any other features such as porous structures to facilitate a biological/non-biological assay within itself or other layers. The porosity may be adjusted for specific applications, such as, without limitation, to let a chemical pass through.

Microfluidic device 100 of FIG. 2 also comprises substrate layer 132, disposed on support layer 130. In some embodiments, substrate layer 132 is made of polydimethylsiloxane (PDMS), although other materials may also be used as discussed above. In some embodiments, substrate layer 132 is made of a material capable of being formed into or comprising a microfluidic circuit. In the particular embodiment illustrated in FIG. 2, substrate layer 132 and top layer 136 (which, according to the embodiment illustrated, is a surface and not a separate layer) are formed as an impression of a silicon wafer mold to create channels and microchambers to form the microfluidic circuit (i.e., microfluidic circuits 110A, 110B, and 110C). Specifically, microfluidic circuits 110A, 110B, and 110C are formed into PDMS substrate layer 132 (having top layer (surface) 136) to create a fluidic pathway from inlet ports 112A, 112B, and 112C to outlet ports 114A, 114B, and 114C, respectively. Inlet ports 112A, 112B, and 112C and outlet ports 114A, 114B, and 114C are fluidically connected via main channels 116A, 116B, and 116C, respectively. In some embodiments, support layer 130 may be visible in, e.g., inlet ports 112A, 112B, and 112C; outlet ports 114A, 114B, and 114C; main channels 116A, 116B, and 116C, and microchambers 118A, 118B, and 118C. In other words, substrate layer 132 is open at the bottom such that support layer 130 forms the bottom of microfluidic circuits 110A, 110B, and 110C. In other embodiments, substrate layer 132 is not open at the bottom, and a portion of substrate layer 132 forms the bottom of microfluidic circuits 110A, 110B, and 110C.

Microfluidic circuits 110A, 110B, and 110C of FIG. 2 each have a design and structure like that of microfluidic circuit 10 of FIG. 1. Specifically, with reference now to just microfluidic circuit 110A, but with corresponding applicability to microfluidic circuits 110B and 110C, microfluidic circuit 110A of FIG. 2 comprises inlet port 112A, outlet port 114A, and main channel 116A. Main channel 116A is fluidically connected to inlet port 112A and outlet port 114A, such that fluid may enter inlet port 112A and travel through main channel 116A and arrive at outlet port 114A. In some embodiments, fluid flows through microfluidic circuits 110A, 110B, and 110C of FIG. 2 in the direction of arrows 150A, 150B, and 150C.

With continued reference to microfluidic circuit 110A of FIG. 2, but with corresponding applicability to microfluidic circuits 110B and 110C, microfluidic circuit 110A also has a series of microchambers 118A of differing volumes disposed within main channel 116A, where each microchamber 118A is individually fluidically connected to main channel 116A via individual microchamber openings (FIG. 3, 152). In some embodiments, the microchambers form a line. In some embodiments, the microchambers are staggered. In some embodiments, the microchambers are positioned in a more random configuration and/or possess a more random size/volume distribution throughout the main channel.

In the embodiment illustrated in FIG. 2, microfluidic circuit 110A (and microfluidic circuits 110B and 110C) is disposed within substrate layer 132, which is contiguous with top layer (surface) 136. Also shown in FIG. 2 a portion of top layer (surface) 136 of microfluidic device 100 has been cut away to reveal microfluidic circuit 110. Underneath top layer 136 of microfluidic device 100 in FIG. 2 are microfluidic circuits 110B and 110C, which are identical or nearly identical in structure to microfluidic circuit 110A, and which are fluidically connected by a cross channel, i.e., connecting channel 134. In some embodiments, the connecting channel is adjacent to the outlet ports. Inlet ports 112B and 112C and outlet ports 114B and 114C can be seen in top layer 136 of FIG. 2 and this same structure would exist for microfluidic device 110A of FIG. 2 (i.e., if a complete (non-cutaway) top layer 136 was shown). In some embodiments, the top layer is disposed on the substrate layer. The top layer of the microfluidic device (136 of FIG. 2) can be substrate layer 132 (i.e., such that top layer 136 is the top surface of substrate 132), or can be any of the substrates described above. In some embodiments, the top layer comprises PDMS. In some embodiments, the top layer comprises glass.

Expanded portion 3 of microfluidic device 100 is illustrated in FIG. 3 to show structure, including depth and side walls of microfluidic circuit 110. In particular, FIG. 3 shows an amplified view of microchamber 118A, which is defined on its exterior by microfluidic device interior wall 120 and defined on its interior by interior wall 122 of substrate 132. Microchamber 118A of FIG. 3 has a diameter shown by arrow 158. Microchamber 118A also has microchamber opening 152, which has a width represented by arrows 154 and a height represented by arrows 156. This same structure (with differing sizes to create differing volumes) is replicated for all microchambers 118A, 118B, and 118C shown in microfluidic device 100 of FIG. 2. In some embodiments, the microchamber shape resembles a boiled egg, where the egg white portion is a protective surrounding layer represented by the substrate material between the interior and exterior walls of the microchamber. This shape provides an appropriate environment for the egg yolk shaped contents of the microchamber to be thermally incubated. In some embodiments, each microchamber comprises an outer wall and an interior wall, wherein the interior wall defines a volume of space constituting the microchamber. In some embodiments, the distance between the microchamber exterior wall and the interior wall is greatest on the side opposite the microchamber opening. In some embodiments, the exterior wall comprises an oval shape or an elongated oval shape and the interior wall defines a circular volume of space constituting the microchamber. In some embodiments, the individual microchamber openings comprise an opening width of 40-100 μm (or any specific width or range therein), each interior wall of the microchambers has a diameter between 200-1500 μm (or any specific diameter or range therein), each inner microchamber space comprises a height of 40-100 μm (or any specific height or range therein), the inlet port comprises a diameter of 500-1500 μm (or any specific diameter or range therein), and the outlet port comprises a diameter of 500-1500 μm (or any specific diameter or range therein). In some embodiments, the height is about 70 μm. In some embodiments, each interior wall of the microchamber decreases in diameter as a microchamber position increases in distance from the inlet port.

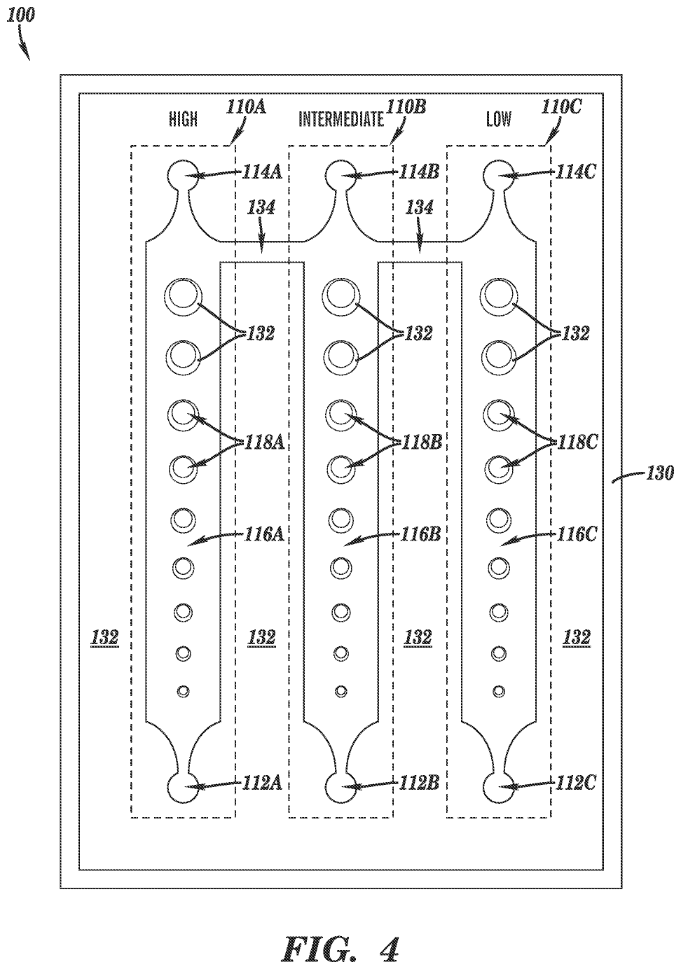

In the embodiment of microfluidic device 100 illustrated in FIG. 2, microfluidic device 100 comprises more than one (i.e., three) microfluidic circuits (as illustrated in FIG. 1), including microfluidic circuits 110A, 110B, and 110C, each of which is essentially identical to each other. Each of microfluidic circuits 110A, 110B, and 110C is disposed within substrate layer 132, which is contiguous with top layer (surface) 136. In addition, microfluidic circuits 110A, 110B, and 110C are connected via a cross channel, specifically, connecting channel 134, which connects each of main channels 116A, 116B, and 116C. While the embodiment illustrated in FIG. 2 shows three microfluidic circuits (110A, 110B, and 110C) in microfluidic device 100, any number of microfluidic circuits may be combined to form a microfluidic device of the present disclosure, including one, two, three, four, five, six, or more microfluidic circuits, as needed for any relevant application. In some embodiments, the microfluidic device comprises at least two microfluidic circuits disposed within the substrate layer. In some embodiments, the microfluidic device comprises at least 3, 4, 5, 6 or more than 6 microfluidic circuits disposed within the substrate layer. The particular structure shown in FIG. 2 with three microfluidic circuits (110A, 110B, and 110C) allows the formation of a microfluidic device where a high, intermediate, and low gradients can be used in performing an assay using the microfluidic device, as described with reference now to FIG. 4.

FIG. 4 is a top view of the microfluidic device of FIG. 2, but with top layer 136 completely removed. As illustrated, three microfluidic circuits are shown to be created in substrate layer 132, including microfluidic circuits 110A, 110B, and 110C labeled “HIGH”, “INTERMEDIATE”, and “LOW” to describe the relative concentration of second reagent solution (discussed below) introduced into each of inlet ports 112A, 112B, and 112C to create a high dose concentration in microfluidic circuit 110A, an intermediate dose concentration in microfluidic circuit 110B, and a low dose concentration in microfluidic circuit 110C. These three concentration gradients are in addition to the concentration gradients created by differently sized microchambers 118A, 118B, and 118C associated with each of microfluidic circuits 110A, 110B, and 110C. These gradients are discussed in more detail in the Examples below.

Movement of fluids into and throughout the microfluidic device of the present disclosure can be controlled manually by introducing solutions into the inlet ports, such as with a syringe attached to tubing, and by diffusion, or by pump connected to one or more inlet ports. Alternatively, the introduction of fluids into and throughout the microfluidic device can be controlled automatically using an operating system programmed to regulate the timing of one or more pipette-like dispersion system, and/or one or more valves responsible for regulating the introduction of fluid (e.g., first reagent, second reagent, isolating solution, etc.). An opening can be introduced into the substrate material at the inlet and outlet ports for this purpose with a tissue culture puncher, as one non-limiting example (see FIG. 2: 112B, 112C, 114B, 114C). In some embodiments, a tissue culture punch of 1 mm is used. In other embodiments, a larger or smaller opening can be made.

Since, as discussed below, one embodiment of methods of using the microfluidic device of the present disclosure is sequential in nature, various systems associated with the microfluidic device may be automated and associated with software that runs on a computer and is easily programmable and modifiable, although one appeal of the microfluidic device of the present disclosure is that it is simple to operate manually by simply introducing a fluid into a microfluidic circuit via an inlet port, and permitting solutions to be transported or diffuse throughout the microfluidic circuit, including into microchambers to create gradients by simple diffusion. However, computers in microfluidic systems could also be used to control system processes and receive signals for interpretation. For example, the computer can control a robotic sub-system that retrieves samples or reagents from storage as needed. The computer can control specimen stations to designate the order of drawing samples and reagents for receipt into the microfluidic device. Pressure differentials and electric potentials can be applied to microfluidic devices by the computer through computer interfaces known in the art, thereby controlling pump devices and valves to regulate the flow of reagents into and out of the system, although these are not necessary in the carrying out assays using the microfluidic device of the present disclosure. The computer can be a separate sub-system, it can be housed as an integrated part of a multi-assay instrument, or dispersed as separate computers in modular subsystems.

A computer system for controlling processes and interpreting detector signals can be any known in the art. The computer can also include a software program, which, for example, is useful for correlating, analysis, and evaluation of detector signals, evaluation of the detector signals to quantify activity, etc. The computer can be in functional communication with the one or more valves controlling the inflow and outflow of fluids, flow rate controllers to control the rate and direction of flow inside the microfluidic device. The computer can also control power circuits, control mechanical actuators, receive the information through communication lines, store information, interpret detector signals, make correlations, etc.

Systems including the microfluidic device of the present disclosure can include, e.g., a digital computer with data sets and instruction sets entered into a software system to practice the assay methods described herein. The computer can be a personal computer with appropriate operating systems and software control, or a simple logic device, such as an integrated circuit or processor with memory, integrated into the system. Software for interpretation of detector signals is available, or can easily be constructed by one of skill using a standard programming language such as Visualbasic, Fortran, Basic, Java, or the like.

The microfluidic device of the present disclosure can be in fluidic contact with variety of specimen manipulation stations. These specimen stations can be, for example, autosamplers, such as sample carousels holding multiple small molecule libraries in a circular tray that can be rotated sequentially or randomly to align the library containers with one or more pipettors. The pipettors can be on actuated arms that can dip the pipettor tube into the specimen for sampling or delivery.

In some embodiments, the samples or reagents are of very small volume, for example, as is typical of many molecular libraries. Sampling from such libraries, e.g., on microwell plates or microarray slides, is typically accomplished with robotic systems that precisely position the pipettor tip in the micro specimen. In embodiments where the library members are retained in dehydrated form, it can be convenient to sample by ejecting a small amount of solvent from the pipettor to dissolve the specimen for receipt into the microfluidic device of the present disclosure.

Reagents can be any composition useful in assays suitable for being carried out with the microfluidic device of the present disclosure, for example, chemicals or biomolecules capable of interacting with target molecules, controlling the reaction conditions, or generating a detectable signal. Reagents are typically one or more molecules in a solution that can flow into contact with the target in a chamber. Reagents can include a chromophore that reacts with the target to provide a changed optical signal.

Within the microfluidic device are microchambers where the first reagent and second reagent come into contact in the particular concentration defined by the size of the microchamber. These microchambers can also be configured to provide conditions amenable to provide a detectable signal resulting from the contact between targets, if necessary.

Microfluidic devices can also have detection regions that can be monitored by detectors which detect the signals, for example, resulting from cellular growth or density, contact of targets, a signal from a reagent that has reacted with a sample analyte, the absence of a detectable signal (interpretable, e.g., as the absence of sample analyte at a level adequate to generate a signal above the sensitivity of the detector), a signal amplitude related to a quantity of a sample analyte, and/or the like. The detection regions are, in some embodiments, the microchambers of the microfluidic circuit. For example, detector regions can incorporate sensors such as pH electrodes and/or conductivity meter electrodes. Detection regions can comprise one or more microchambers transparent to certain light wavelengths so that light signals, such as, absorbance, fluorescent emissions, chemoluminescence, and the like, can be detected. Detectors can be located in the microfluidic device, or proximate to the device, in an orientation to receive signals resulting from the sample contact with the reagent. Detectors can include, e.g., a nucleic acid sequencer, a fluorometer, a charge coupled device, a laser, a photo multiplier tube, a spectrophotometer, scanning detector, microscope, or a galvo-scanner. Signals detected from interactions of reagents and samples can be, e.g., absorbance of light wavelengths, light emissions, radioactivity, conductivity, refraction of light, etc. The character of signals, such as, e.g., the amplitude, frequency, duration, counts, and the like, can be detected.

Detectors can detect signals from detector regions described by physical dimensions, such as a point, a line, a surface, or a volume from which a signal can emanate. In some embodiments, the detector can scan an image of a surface or volume for signals resulting from interactions of reagents and samples. For example, a detector can contemporaneously image multiple parallel microchambers carrying reaction mixtures from multiple analyses to detect results of several different assays at once.

The detectors can transmit detector signals that express characteristics of resultant signals received. For example, the detector can be in communication with an output device, such as an analog or digital gage, that displays a value proportional to a resultant signal intensity. The detector can be in communication with a computer through a data transmission line to transmit analog or digital detector signals for display, storage, evaluation, correlation, and the like.

In some embodiments, detecting an interaction between the first reagent solution and the second reagent solution comprises detecting a visual signal. In some embodiments, detecting an interaction between the first reagent solution and the second reagent solution comprises detecting a fluorescent signal. In some embodiments, detecting an interaction between the first reagent solution and the second reagent solution comprises detecting a colorimetric signal. In some embodiments, detecting an interaction between the first reagent solution and the second reagent solution comprises detecting a spectrophotometric signal.

A further aspect of the present invention relates to kits that include a microfluidic device of the present disclosure and, optionally, one or more pools of reagents for carrying out assays suitable to the microfluidic device described herein.

Another aspect of the present disclosure relates to a method for performing an assay. This method involves loading a first reagent solution into the inlet port of a microfluidic device of the present disclosure. A second reagent solutions is loaded into the inlet port. An isolating solution is loaded into the inlet port. The method further involves detecting an interaction between the first reagent solution and the second reagent solution in one or more of the microchambers.

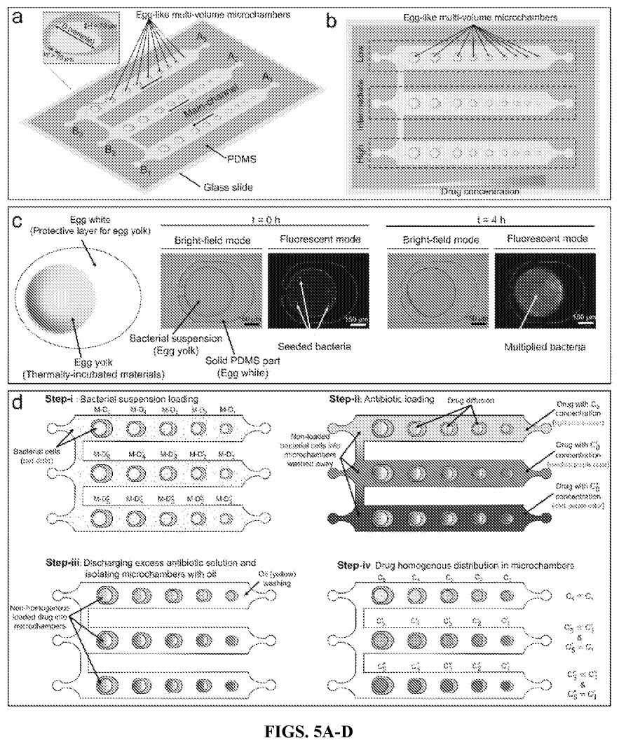

Turning now to FIG. 5D, illustrated is one embodiment of a method of performing an assay using the microfluidic circuit and/or device of the present disclosure. In the particular embodiments illustrated in FIG. 5D and described in further detail in the Examples, this method is carried out by carrying out a series of “loading” steps, including: Step-i: Bacterial suspension loading; Step-ii: Antibiotic loading; Step-iii: Oil washing step to discharge the excess antibiotic solution from the main-channel; and Step-iv: Drug homogenous distribution into microchambers. In Step-i illustrated in FIG. 5D, a first reagent solution (e.g., comprising a bacterial suspension) is loaded into the inlet port of a microfluidic device of the present disclosure until a uniform concentration of the first reagent solution is achieved throughout all microfluidic circuits in the microfluidic device. In Step-ii illustrated in FIG. 5D, a second reagent solution (e.g., comprising an antibiotic solution to be tested against the first reagent solution) is loaded into the inlet ports. The second reagent solution is transported or permitted to diffuse throughout the microfluidic circuit from the injection site (i.e., inlet port). In some embodiments, the second reagent solution is loaded into the microfluidic circuits in three different concentrations, respectively, at three orders of magnitude (C₀, 0.1 C₀, and 0.01 C₀) represented by degree of shading in each of the microfluidic circuits, as shown in FIG. 5D. The timing of loading the second reagent solution to produce a gradient concentration profile (GCP) in the microchambers is determined by the small-molecule diffusion coefficients and diffusion time of the small molecule. In Step-iii, an isolating solution is loaded into the inlet ports of each of the microfluidic circuits to stop the loading time of the second reagent solution into the microchambers (e.g., by washing the main-channels with a biocompatible oil to isolate the microchambers containing the biological species and small-molecules). In Step-iv, a homogenous distribution of the second reagent solution is achieved. As a result, the smallest and largest microchambers in each row feature the highest and lowest concentrations of the second reagent solution in the low, intermediate, and high ranges.

Thus, in carrying out the method of the present disclosure, the pattern illustrated in FIG. 5D may be carried out, which involves (i) loading a bacterial suspension to diffuse equally through the microfluidic circuit(s) of the microfluidic device; (ii) loading an antibiotic solution into each of inlet ports of all of the microfluidic circuits of the microfluidic device, each at a different concentration, to create a second layer of concentration gradients in the microfluidic device; (iii) washing the main channel of each microfluidic circuit step-by-step after the introduction of an antibiotic solution into the circuit to prevent transport or diffusion of the small molecule solution out of the microchambers; and (iv) allowing uniform distribution of the small molecule solution throughout the microchambers to create concentration gradients in each of the microfluidic circuits.

Other variations may also be used based on loading of a bacterial suspension, loading of an antibiotic solution, loading an isolating solution, and achieving distribution of the antibiotic solution to detect effectiveness of the antibiotic solution against the bacterial suspension at the various concentrations created in the microfluidic device.

In some embodiments, when loading the first reagent into the microfluidic circuit, the first reagent fills the microchambers. Creating an even distribution of first reagent throughout the microfluidic circuit ensures that true concentration gradients of the second reagent are achieved.

In some embodiments, the second reagent solution is loaded into the inlet port(s) of the microfluidic device and allowed to diffuse throughout the circuit and into the microchambers. In some embodiments, a portion of the second reagent solution diffuses into the microchambers, thereby forming a concentration gradient of the second reagent solution within the microchambers from the inlet port to the outlet port. In some embodiments, a third reagent may be loaded prior to the isolating solution. In some embodiments, a forth reagent may be loaded prior to the isolating solution. In some embodiments, a fifth, a sixth, a seventh, an eighth, or more than eighth reagent may be loaded prior to the isolating solution.

In some embodiments in carrying out the methods described herein, one microfluidic circuit is loaded with the second reagent at a time. In some embodiments in carrying out the methods described herein, one microfluidic circuit is loaded with the second reagent while the inlet and outlet ports of other microfluidic circuits of a microfluidic device are blocked, sealed, or closed. A blocking element may be used for blocking, sealing, or closing inlet and outlet ports of the microfluidic device of the present application. Blocking, sealing, or closing inlet and outlet ports may be carried out by any suitable means including, without limitation, by sealing the ports with tape, inserting a block agent into the ports, or fitting tubing into the ports and sealing the tubing. Blocking may be carried out reversibly to allow access to the inlet and outlet ports at various times during the methods described herein. After loading of all reagent solutions and biocompatible oil, blocking may be carried out permanently. Inlet and outlet ports may be open or blocked as needed for the loading of the first reagent, the second reagent, and the isolating solution(s). In some embodiments, the microfluidic inlet port and outlet port comprise a blocking element. Similar methods with different loading arrangement may be used depending on the application.

In carrying out the methods of the present application, the isolating solution is used to prevent transport or diffusion of the first reagent solution and second reagent solution from the microchambers or any two consecutive loaded/loading reagents in general aspects. Suitable isolating solutions include, without limitation, a biocompatible oil such as glycerol, vegetable oil, and silicon oil. Other substances may be used, including, for example, those that are more viscous than water and/or are hydrophobic. In some embodiments, the isolating solution comprises a biocompatible oil.

In some embodiments in carrying out the methods described herein, the microfluidic device is loaded with a first reagent solution into the inlet port of one or more of the microfluidic circuits, while the outlet ports are open. All inlet and outlet ports can then be blocked except for one inlet port in order to complete the loading of the first reagent. Due to the pressure of the solution flow, entrapped air in the microchambers escapes through the PDMS walls, resulting in a uniformly loaded first reagent throughout the device. Inlet and outlet ports can be used interchangeably for this process. After the first reagent is loaded, if desired, a negative control microfluidic circuit can then be washed with an isolating solution to prevent the microchambers in that circuit from receiving any further solutions. In some embodiments, the inlet and outlet ports for the other microfluidic circuits are blocked during this process.

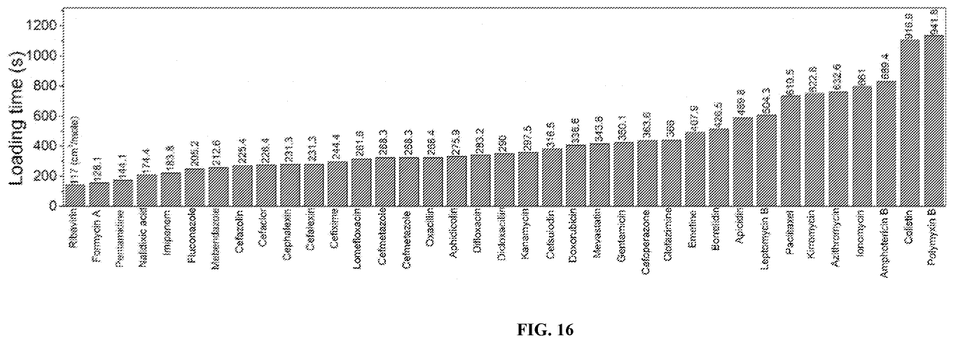

In further embodiments in carrying out the methods described herein, the microfluidic device is then loaded with a second reagent solution for a specified time, followed by an isolating solution, as discussed in the Examples. In some embodiments, the isolating solution prevents transport or diffusion of the first reagent solution and the second reagent solution from the microchambers. In some embodiments, the inlet and outlet ports of circuits that are not being loaded with the second reagent solution or the isolating solution are blocked. The timing of loading of the second solution in order to produce a gradient concentration profile (GCP) in the microchambers is determined by the small-molecule diffusion coefficients and diffusion time of the small molecule. The loading time can be determined empirically, or calculated as shown in the Examples. Exemplary loading times for various chemicals are described in the Examples below, and FIG. 16.

The microfluidic circuits and devices of the present disclosure can be used to perform a variety of assays. Accordingly, the first reagent may be any number of possible substances, including, for example and without limitation, a biological sample. In some embodiments, the biological sample comprises a prokaryotic cell or prokaryotic cell component. In some embodiments, the biological sample comprises a eukaryotic cell or eukaryotic cell component.

Suitable second reagent solutions may comprise an antimicrobial compound. Thus, the method of the present disclosure may be carried out to perform an assay testing the ability of a compound (e.g., small molecule) to act as an antimicrobial compound. Moreover, the method may be carried out to determine an effective or ideal concentration at which an antimicrobial compound may be used to achieve its desired effect.

Antimicrobial compounds are well known in the art. Non-limiting examples of antimicrobial compounds that may be used in the assay method of the present disclosure include, without limitation, Actinomycin D, Actinonin, Aculeacin A, Acycloguanosine (Aciclovir), Adenine 9-β-D-arabinofuranoside (Vidarabine), Alamethicin, L-Alanyl-L-1-aminoethylphosphonic acid (Alafosfalin), Albendazole (Methyl 5-(propylthio)-2-benzimidazolecarbamat), 17-(Allylamino)-17-demethoxygeldanamycin (Tanespimycin), Amastatin, Amikacin, 7-Aminoactinomycin D (7-ADD), 7-Aminocephalosporanic acid (7-ACA), 7-Aminodesacetoxycephalosporanic acid (7-ADCA), (+)-6-Aminopenicillanic acid (6-APA), Amoxicillin, Amphotericin B (Fungizone), Ampicillin (D-(−)-α-Aminobenzylpenicillin), Anhydroerythromycin A, (Erythromycin, or 2BR5PL6H3), Anisomycin (or, Flagecidin), Aphidicolin, Apicidin, Apoptolidin (FU 40A), Apramycin (Nebramycin II), Artesunate, Ascochlorin (Ilicicolin D, NSC 287492), Ascomycin (KD4185000), Azacitidine (Ladakamycin), Azithromycin, Azlocillin (D-α-([Imidazolidin-2-on-1-yl]carbonylamino)benzylpenicillin), Bacitracin, Bafilomycin A1 (4730700), Bafilomycin B1, Bestatin (Ubenimex), Bithionol, Blasticidine (Blasticidin S), Borrelidin, Brefeldin A (Ascotoxin, BFA, Cyanein, Decumbin), Caerulomycin A (Carulomycin A, Cerulomycin), Calcium ionophore III (ANTIBIOTIC A 23187, Calimycin), (S)-(+)-Camptothecin, (Camptothecin), Carbenicillin (α-Carboxybenzylpenicillin), Cefaclor, Cefalexin, Cefazolin, Cefixime, Cefmetazole, Cefoperazone, Cefotaxime ((Z)-Cefotaxime), Cefmetazole, Cefoperazone, Cefsulodin (Ulfaret), Ceftazidime, Ceftriaxone, Cephalexin, Cephalomannine (NSC 318735), Cephalothin (Cefalotin), Cephradine (Cefradine), Cercosporin, Cerulenin, Chloramphenicol, Chlorhexidine, Chloroquine, Chlortetracycline, Chromomycin A3, Chrysomycin A (MFCD07370133), Chrysomycin B (MFCD07370132), Cinoxacin, Clarithromycin, Clindamycin (Cleocin), Clofazimine, Clotrimazole, cloxacillin, Colistin, Concanamycin A (Folimycin), Cordycepin (3′-Deoxyadenosine), Coumermycin A1, Cryptotanshinone (Tanshinone C), Cycloheximide (Actidione, Naramycin A), D-Cycloserine, Cyclosporin A (Antibiotic S 7481F1, Cyclosporine), Cytochalasin D (Zygosporin A, 1632828), Cytochalasin B (Phomin), Dacarbazine ((E)-Dacarbazine), Daptomycin, Daunorubicin (Daunomycin), 10-Deacetylbaccatin III, Demeclocycline, 1-Deoxymannojirimycin, Dichlorophene, Dicloxacillin, Difloxacin, Dihydrostreptomycin, Dimetridazole, Dirithromycin, Doxorubicin, Doxycycline, Duramycin, Econazole, Embelin (Embelic acid, Emberine), Emetine, Enrofloxacin (Baytril), Erythromycin (E-Mycin, Erythrocin), Ethambutol ((+)-S,S-Ethambutol), Etoposide, Florfenicol (Aquafen, Nuflor), Flubendazol (Flumoxanal), Fluconazole, Flumequine, 5-Fluorocytosine (Flucytosine), Flurbiprofen, Formycin A (Adenosine, Formycin, NSC 102811), Fumagillin, Furazolidone, Fusaric acid (5-Butylpicolinic acid), Fusidic acid, G 418, Ganciclovir, Gatifloxacin, Gentamicin, Gliotoxin, gramicidin s, Griseofulvin, Herbimycin A, Honokiol, 8-Hydroxyquinoline, 4-Hydroxytamoxifen ((Z)-Afimoxifene), Hygromycin B (WK2130000), Ikarugamycin, Imipenem, Ionomycin, Irgasan, Itraconazole, Ivermectin Bla, Josamycin, K-252a, Kanamycin, Ketoconazole, Kirromycin (mocimycin), Lactoferricin B (metallibure), Leptomycin A, Leptomycin B, Levamisol (Levamisole), Levofloxacin, Lincomycin, Lomefloxacin, Lysobactin, Magainin I, Mebendazole, Meclocycline, N-Methyl-1-deoxynojirimycin (1524564), Metronidazole, Mevastatin, Miconazole, Minocycline, Mithramycin A (Plicamycin), Mitomycin C (Mitomycin), Monensin, Moxalactam (Latamoxef), Mupirocin, Myxothiazol, Nafcillin, Naftifine, Nalidixic acid, Narasin, Neocarzinostatin (Holoneocarzinostatin, NCS, NSC-69856, Zinostatin), Neomycin, Netilmicin, Netropsin (Congocidin, Sinanomycin), Niclosamide, Nigericin (Antibiotic K178, Antibiotic X464, Azalomycin M, Helexin C, Polyetherin A), Nikkomycin, Nitrofurantoin (Furadoxyl, Nitrofurantoine), Nonactin (Ammonium ionophore), Norfloxacin, Novobiocin, Nystatin (Fungicidin, Mycostatin), Ochratoxin A, Ofloxacin, Oligomycin A, Oxacillin, Oxolinic acid, Oxytetracycline, Paclitaxel, Paromomycin, Patulin, PD 404,182, Pefloxacin, Penicillin G (Benzylpenicillin), Pentamidine, Phenazine, Phleomycin (UNII:BN3E7WJN9X), Phosphomycin (Fosfomycin), Pimaricin (Natamycin), Pipemidic acid, Piperacillin, Pirarubicin (THP), Polymyxin B, Praziquantel, PUROMYCIN, Pyrazinecarboxamide (Pyrazinamide, Pyrazinoic acid amide), Pyronaridine, Pyrrolnitrin, Quinine, 8-Quinolinol (8-Hydroxyquinolin, Oxine), Radicicol, Rapamycin (Sirolimus), Reveromycin A (MFCD00912537), Ribavirin, Ribostamycin, Rifabutin (Ansamycin, Ansatipine (Farmitalia), LM-427, Mycobutin (Farmitalia)), Rifampicin (Rifampin, Rifamycin AMP), Rifapentine (DL 473), Rifaximin (Rifacol), Roxithromycin, Salinomycin, Sisomicin, Sorbic acid, Sordarin, Sparfloxacin, Spectinomycin, Spergualin, Spiramycin, Staurosporine (Staurosporine), Streptomycin, Streptonigrin (Bruneomycin, Nigrin), Streptozocin (Streptozotocin), Prothionamide, and Monensin.

Suitable second reagent solutions may also comprise an anticancer compound or drug. According to some embodiments, when the second reagent solution comprises an anticancer compound or drug, the first biological sample of the first reagent solution is a cancer cell or a component of a cancer cell. Thus, the method of the present disclosure may be carried out to perform an assay testing the ability of a compound (e.g., small molecule) to act as an anticancer drug. Moreover, the method may be carried out to determine an effective or ideal concentration at which an anticancer compound may be used to achieve its desired effect. Anticancer compounds are well known in the art. Non-limiting examples of anticancer compounds that may be used in the assay method of the present disclosure include, without limitation, Abemaciclib (Verzenio), Abiraterone acetate (Zytiga), Acalabrutinib, Afinitor (Everolimus), Aldara (Imiquimod), Alectinib, Alemtuzumab, Alimta (Pemetrexed Disodium), Aliqopa (Copanlisib Hydrochloride), Aloxi (Palonosetron Hydrochloride), Alunbrig (Brigatinib), Ameluz (Aminolevulinic Acid), Amifostine, Anastrozole, Apalutamide, Aprepitant, Arimidex (Anastrozole), Aromasin (Exemestane), Arranon (Nelarabine), Axitinib, Azacitidine (Vidaza), Azedra, Beleodaq (Belinostat), Bendamustine Hydrochloride, Bexarotene (Targretin), Bicalutamide (cosodex), BiCNU (Carmustine), Binimetinib, Bortezomib (Velcade), Bosutinib, Braftovi (Encorafenib), Brigatinib, Busulfan, Cabazitaxel, Calquence (Acalabrutinib), Campath (Alemtuzumab), Camptosar (Irinotecan Hydrochloride), Capecitabine (Xeloda), Carac (Fluorouracil-Topical, Tolak), Carfilzomib (Kyprolis), Carmustine, Ceritinib (Zykadia), Cerubidine (Daunorubicin Hydrochloride), Chlorambucil, Cladribine, Clofarabine, Cobimetinib, Copanlisib Hydrochloride, Copiktra (Duvelisib), Cosmegen (Dactinomycin), Crizotinib (Xalkori), Cyclophosphamide, Cytarabine (Tarabine PFS), Dabrafenib (Tafinlar), Dacarbazine, Dacogen (Decitabine), Dacomitinib (Vizimpro), Dasatinib, Daunorubicin Hydrochloride, Decitabine, Degarelix, Dexamethasone, Dexrazoxane Hydrochloride (Totect, Zinecard), Docetaxel (Taxotere), Doxorubicin, Duvelisib, Leuprolide Acetate, Ellence (Epirubicin Hydrochloride), Eltrombopag Olamine, Emend (Aprepitant), Enasidenib Mesylate, Enzalutamide (Xtandi), Epoetin Alfa, Eribulin Mesylate, Erivedge (Vismodegib), Erleada (Apalutamide), Erlotinib Hydrochloride (Tarceva), Ethyol (Amifostine), Etopophos (Etoposide Phosphate), Everolimus, Evista (Raloxifene Hydrochloride), Evomela (Melphalan Hydrochloride), 5-FU (Fluorouracil Injection), Fareston (Toremifene), Farydak (Panobinostat), Faslodex (Fulvestrant), FEC, Femara (Letrozole), Firmagon (Degarelix), Fludarabine Phosphate, Flutamide, Folotyn (Pralatrexate), Fusilev (Leucovorin Calcium), Gefitinib, Gemcitabine Hydrochloride, Gilotrif (Afatinib Dimaleate), Gleevec (Imatinib Mesylate), Gliadel Wafer (Carmustine Implant), Goserelin, Acetate (Zoladex), Granisetron, Halaven (Eribulin Mesylate), Hemangeol (Propranolol Hydrochloride), Hycamtin (Topotecan Hydrochloride), Hydrea (Hydroxyurea), Ibrance (Palbociclib), Ibritumomab Tiuxetan (Zevalin), Ibrutinib, Iclusig (Ponatinib Hydrochloride), Idarubicin Hydrochloride, Idelalisib (Zydelig), Ifex (Ifosfamide), Imiquimod, Ipilimumab (Yervoy), Istodax (Romidepsin), Ivosidenib (Tibsovo), Ixabepilone, Ixazomib Citrate, Ruxolitinib phosphate, Kisqali (Ribociclib), Lanreotide Acetate, Larotrectinib Sulfate (Vitrakvi), Lenalidomide, Lenvatinib Mesylate, Lomustine, Lorbrena (Lorlatinib), Lupron (Leuprolide Acetate), Lynparza (Olaparib), Marqibo (Vincristine Sulfate Liposome), Matulane (Procarbazine Hydrochloride), Mechlorethamine Hydrochloride, Megestrol Acetate, Mekinist (Trametinib), Melphalan, Mercaptopurine, Methotrexate, Midostaurin, Mitomycin C, Mitoxantrone Hydrochloride, Mozobil (Plerixafor), Mustargen (Mechlorethamine Hydrochloride), Myleran (Busulfan), Navelbine (Vinorelbine Tartrate), Nelarabine, Neratinib Maleate, Neulasta (Pegfilgrastim), Nexavar (Sorafenib Tosylate), Nilandron (Nilutamide), Nilotinib (Tasigna), Ninlaro (Ixazomib Citrate), Odomzo (Sonidegib), Omacetaxine Mepesuccinate, Osimertinib (Tagrisso), Paclitaxel (Taxol), PAD, Palbociclib, Palonosetron Hydrochloride, Panobinostat, Pazopanib Hydrochloride (Votrient), Pegfilgrastim (Zarxio), Pomalidomide, Prednisone, Procarbazine Hydrochloride, Promacta (Eltrombopag Olamine), Purinethol, Raloxifene Hydrochloride, Regorafenib, Ribociclib, Rheumatrex (Methotrexate, Trexall), Rolapitant Hydrochloride, Romidepsin, Rubidomycin (Daunorubicin Hydrochloride), Rydapt (Midostaurin), Sancuso (Granisetron), Somatuline Depot (Lanreotide Acetate), Sonidegib, Stivarga (Regorafenib), Tabloid (Thioguanine), Temodar (Temozolomide), Temsirolimus (Torisel), Thalidomide, Thiotepa, Toremifene, Trabectedin (Yondelis), Treanda (Bendamustine Hydrochloride), Trifluridine and Tipiracil Hydrochloride, Uridine Triacetate (Vistogard), Valrubicin, Vandetanib, Varubi (Rolapitant Hydrochloride), Vemurafenib (Zelboraf), Venclexta (Venetoclax), Vinblastine Sulfate, Vismodegib, Vorinostat (Zolinza), Xospata (Gilteritinib Fumarate), Zofran (Ondansetron Hydrochloride), and Zoledronic Acid (Zometa).

Suitable second reagent solutions may also comprise an antifungal drugs and other small molecules (e.g., for testing on yeast or other fungal species). Thus, the method of the present disclosure may be carried out to perform an assay testing the ability of a compound (e.g., small molecule) to act as an antifungal drug. Moreover, the method may be carried out to determine an effective or ideal concentration at which an antifungal compound may be used to achieve its desired effect. Antifungal compounds are well known in the art. Non-limiting examples of antifungal compounds that may be used in the assay method of the present disclosure include, without limitation, D-fructose, Glucose, Galactose, Antimycin, Bleomycin, 5-Bromo-5-nitro-1,3-dioxane, Cinnamycin, Fengycin (Plipastatin), Filastatin, Filipin, Gentian Violet, Sinefungin, Kasugamycin, Magnolol (2,2′-Bichavicol, 5,5′-Diallyl-2,2′-biphenyldiol), Oligomycin (Oligomycin A), Surfactin, Terconazole, Thiabendazole (2-(4-Thiazolyl)benzimidazole), Thiolutin, Thymol (5-Methyl-2-isopropylphenol), Tioconazole, Tolnaftate, Tubercidin, Terbinafine, Ketoconazole, Fluconazole, Itraconazole, Voriconazole, Caspofungin, and Flucytosine.

In further embodiments, the microfluidic device is incubated at a temperature conducive to growth of the biological solution. In some embodiments, the microfluidic device is placed in a water bath for thermal incubation.

The following examples are intended to exemplify the practice of embodiments of the disclosure but are by no means intended to limit the scope thereof.

### EXAMPLES

### Example 1—Materials and Methods

Materials. SU-8 2050 negative photoresist and developer were obtained from Microchem Corp. (Westborough, MA). Polydimethylsiloxane (PDMS, Sylgard 184) and the PDMS curing agent were purchased from Dow Corning (Midland, MI). Silicon wafers were purchased from University Wafer (Boston, MA). Cellophane tape was purchased from 3M (Scotch Magic). Polyethylene tubing (i.d.=0.38 mm, o.d.=1.09 mm), 27-gauge syringe needles, and 3 mL Luer-Lok tip disposable syringes were purchased from Becton Dickinson (Franklin Lakes N). Resazurin and antibiotics used in this study were purchased from Sigma-Aldrich (St. Louis, MO). Cation adjusted Mueller-Hinton (“MH”) broth was purchased from Sigma-Aldrich (St. Louis, MO).

EL-MTV² Device Fabrication. The instructions provided by Microchem (Westborough, MA) were followed for the EL-MVM² device fabrication. The design of the EL-MVM² platform was patterned on a silicon wafer by SU-8 2050, using well-established soft lithography techniques. In detail, spin-coating (speed=2800 rpm and time=2 min) was used and patterned a thin 70 μm SU-8 2050 on pre-cleaned silicon wafer. SU-8 layer was then pre-baked at 65° C. and 95° C. for 3 and 7 min, respectively. The pre-baked SU-8 layer was then solidified using ultraviolet light exposure (175 mj/cm² for 10 s). The patterned silicon wafer was post-baked at 95° C. for 5 min and developed using SU-8 developer. The mixture of PDMS and its curing agent (10:1) was then poured on the SU-8 deposited wafer and baked for 2 h at 65° C. After peeling the PDMS off the patterned wafer, injection holes (1 mm in diameter) were punched and cleaned by a cellophane tape (3M Scotch Magic, MN, USA), followed by bonding of PDMS to a glass slide by applying oxygen-plasma treatment for 1 min. To further stabilize the bonding strength between PDMS and the glass slide, the device was kept at 65° C. in an oven for 12 h for further stabilization.

Growth media and bacterial culture conditions. The non-selective MH culture medium broth to culture bacteria was used. In this respect, a colony of each bacterial strain from a fresh streak plate was suspended into 3 mL of pure MH culture medium in a bacterial culture tube. The tubes were kept on a shaker (shaking at 225 rpm) overnight at 37° C. After 12 h incubation, the overnight bacterial culture concentrations was adjusted to the desirable concentration (1×10⁶ CFU/mL) by a UV-Vis spectrophotometer (NanoDrop, Thermo Scientific, Wilmington, DE) for use in the AST assays.

Broth Microdilution Test. The gold standard broth microdilution test was used to compare the AST results obtained using the EL-MVM² platform with a gold standard technique. The broth microdilution technique protocol was used as discussed elsewhere (see Azizi et al. “Nanoliter-Sized Microchamber/Microarray Microfluidic Platform for Antibiotic Susceptibility Testing,” Anal. Chem. 90, 14137-14144 (2018), which is hereby incorporated by reference in its entirety). In this respect, the target-of-interest antibiotics' stock solution (C₀=200 μg/mL) was prepared in MH culture medium. Then, 200 μL antibiotic solutions at final targeted concentrations were reconstituted into each well of a 96 MicroWell plate (Falcon, BD Biosciences) by diluting the initial antibiotic stock solution using the pure MH culture medium solution. Then, 10 μL of each bacterial stock suspension was added to each well containing already-added antibiotic solution to obtain the initial 1×10⁶ CFU/mL bacterial suspension concentration. For negative control, only the 10 μL of each bacterial stock suspension was added into each well filled by 200 μL of MH culture medium (no added antibiotic). Then bacterial suspension in each well of 96 well-plate incubated for more than 24 h to record the changes in optical density over bacterial growth time. The MIC and susceptibility time were measured upon 80% reduction in OD_{600 nm}-growth curves than the negative control (without adding any antibiotic to bacterial suspension). The broth microdilution test was performed in triplicate.

Antibiotic susceptibility experiments and data analyses from images. Fluorescent images were taken every 1 or 1.5 h. For red fluorescent images, representing the bacterial cell metabolites through resazurin reduction mechanism, the average fluorescent intensities of each microchamber was recorded and converted to gray-values using ImageJ software. For green fluorescent images, representing the single cell bacterial growth, the images were taken only upon loading the GFP-labeled bacterial suspension sample into the EL-MVM² platform (t=0 h) and after every 1 or 1.5 h incubation of bacteria in an AST assay. The images at other time-points (t>1 h or 1.5 h) were not used as the differentiation between bacterial single cells was not practical into microchambers. Images were taken using a ZOE Fluorescent Cell Imager (Bio-Rad, California, USA). For each experiment, each position was imaged every 1 h or 1.5 h (depending on the bacterial growth and changes the fluorescent intensity emitted from resazurin reduction due to the bacterial cell metabolites) for a 6-h time-period. The first imaging (t=0 h) was performed right away after oil washing step and isolating the microchambers.

CFD Simulations. To simulate the transport of antibiotic molecules, the Navier-Stokes and mass conservation equations (Eq. 1 & 2) were numerically solved at no-slip boundary conditions using the finite element method to exploit the fluid velocity field within the microfluidic layout. By plugging the obtained velocity field in the diffusion-convection and conservation of concentration equations (Eq. 3 & 4, respectively), and solving the equations using the finite element method, the concentration of the antibiotic solution is yielded. Since the microfluidic design for probing antibiotic resistance is mainly comprised of a straight channel, the secondary streamlines (i.e., flow streamlines in the side microchannel) can be considered negligible. Accordingly, the transport of the antibiotic molecules from laminar flow to the

v·∇(v)=μ∇·(∇v+(∇v)^{T})−∇(p) (1)

∇·v=0 (2)

∂c/∂t+v·∇(c)=D∇²(c) (3)

∇·c=0 (4)

adjacent resazurin solution flow is solely described by molecular diffusion. That is, the left side of Eq. 3 vanishes and Eq. 4 is obtained.

### Example 2—EL-MVM² Platform Features and Functionality

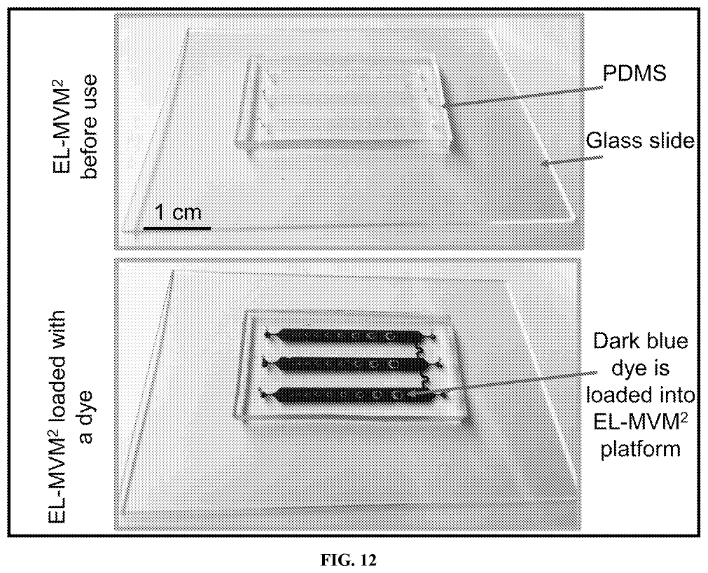

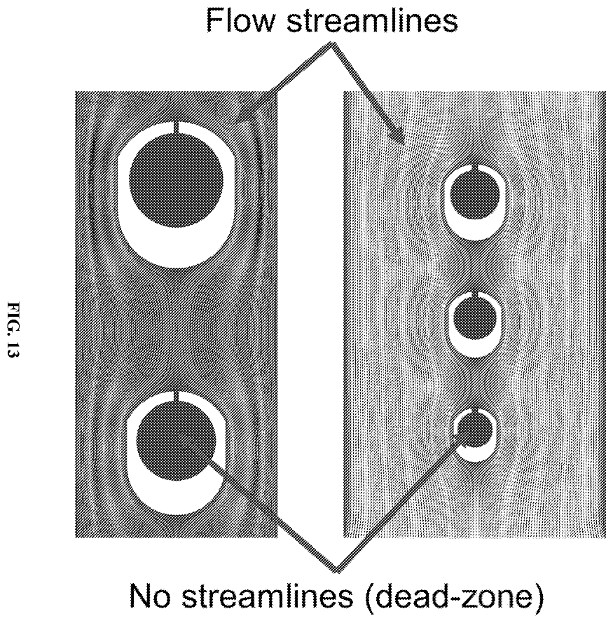

Different parts of the EL-MVM² platform are described below as well as how the formation of the antibiotic gradient-based concentration profile (GCP) can be obtained in a single test. In this respect, FIG. 5A demonstrates the perspective view of the EL-MVM² platform, as it includes microchambers featured into three main-channels with openings A₁-A₃ and B₁-B₃. A microchamber is magnified in inset scheme of FIG. 5A, showing the height and width (H and W, respectively) of all microchambers are 70 μm, but notice that the diameters (D) of microchambers are variable, as shown in FIG. 5A. In FIG. 11, the microchambers' sizes and the naming for microchambers are shown—as called by M-Dᵢ, where “M” and “D” stand for the first letters of the “microchamber” and “diameter” words and “i” represents the microchamber i^{th}. The actual sizes of multi-volume microchambers M-D₁-M-D₉ are depicted in FIG. 11. Moreover, the digital images of the EL-MVM² platform before and after loading with a dye are shown in FIG. 12. To load the bacterial suspension, a 3 ml syringe was used with tubing connected to the needle of syringe to introduce the suspension into the device at inlet port A1. During this initial loading, all other openings (inlet and outlet ports A₂-A₃ and B₁—B₃) were open until the main-channels were filled with bacterial suspension. Since the bacterial suspension could not enter the side-channel and consequently the microchamber due to air entrapment, openings A2-A3 and B1-B3 were then blocked to apply the bacterial suspension through inlet port A1 with more force. Air in the microchamber escaped through the microchambers' side-walls and roof into the PDMS, allowing the microchambers to be completely filled with bacterial suspension.

To produce a wide antibiotic GCP (e.g., between 2-3 orders of magnitude) in the EL-MVM² platform, this wide concentration range was divided into three sub-concentration GCPs such as, low, intermediate, and high ranges (FIG. 5B). In each sub-concentration GCP, the smallest (M-D₁) and largest (M-D₉) microchambers produce the highest and the lowest concentrations in that subcategory, respectively, as highlighted in FIG. 5B.

The EL-MVM² design was inspired by a boiled egg, where the egg white is a protective surrounding layer serving as a thermal incubator, providing an appropriate environment for egg yolk to be thermally treated, as shown in FIG. 5C. Similarly, the microchambers including the solid PDMS walls and the loaded bacterial suspension into the hollow middle compartment resemble the egg white and egg yolk, respectively, as highlighted in bright-field image at t=0 h in FIG. 5C. To visualize this functionality, the bright-field and fluorescent images showed a loaded green-fluorescent protein (GFP)-labeled bacterium (E. coli 541-15) into a microchamber at t=0 h and t=4 h (after 4-h incubation at 37° C.) in FIG. 5C. The microchamber wall excellently saved the culture medium into the microchamber after 4-h thermal incubation. Moreover, the fluorescent images show how bacteria grew and multiplied in the microchamber within 4-h culture.

In terms of EL-MVM² platform functionality, there are four main, quick steps to consider to make the EL-MVM² platform operational for an AST assay (FIG. 5D). For simplicity, only five microchambers were shown in each main-channel diagram of FIG. 5D, but more chambers can be added. As shown in FIG. 5D, Step-i, the bacterial suspension is initially loaded into EL-MVM² platform as described above. Then the antibiotic drug solutions are prepared in three syringes with the predetermined C₀, C₀′, and C₀″ concentrations and loaded into low, intermediate, and high main-channels, respectively (FIG. 5D, Step-ii). The loading of drug solutions also helps to discharge the non-loaded bacterial cells from the main-channels while the drug starts to diffuse into microchambers. For example, referring to FIG. 5A, to load the drug solution into the first main-channel, openings A2, A3, B2, and B3 are temporarily blocked, and the first concentration of the drug solution (C0) is loaded from A1 and discharged from B1. This drug loading pushes the remaining bacterial suspension in the main-channel associated with A1 to B1 openings out of that main-channel (A1 to B1). Then, the drug is loaded within the measured loading time appropriate to that drug (see FIG. 16 for examples). When the drug is loaded though a drug diffusion mechanism, another ready-to-use syringe containing the biocompatible oil is connected to inlet port A1, to load the oil into main-channel in the direction of A1 to B1. This oil loading process similarly flushes the remaining drug solution from the A1 to B1 main-channel and isolates the microchambers in this main-channel corresponding to A1 to B1 from each other.

Next, openings A1 and B1 are permanently blocked (they already have bacterial suspension and drug loaded into the microchambers which have been isolated with oil). While inlet port A3 and outlet port B3 are temporarily blocked, the drug solution with concentration C1 is loaded from inlet port A2 and discharged from outlet port B2. The loading of drug with concentration C1 pushes the remaining bacterial suspension in the main-channel out of the main-channel associated with A2 to B2. Then, drug with concentration C1 is loaded within the measured loading time into microchambers associated with this main-channel. When the drug is loaded though a drug diffusion mechanism, the syringe containing the oil is connected to port A2 and loaded from A2 discharged from B2 through the main channel connecting these ports. This oil loading process similarly flushes the remaining drug solution from this main-channel and isolates the microchambers in this main-channel from each other.

Next, openings A2 and B2 are permanently blocked since the microchambers in this channel have bacterial suspension, drug, and have already isolated with oil). Then drug solution with concentration C2 is loaded through port A3 into microchambers associated with the A3 to B3 main-channel. As with the other channels, the drug with concentration C2 is loaded from A3 and discharged from B3, pushing the remaining bacterial suspension in the main-channel A3 to B3 out of this main-channel. Then, the drug is loaded within the measured loading time into microchambers associated with this main-channel A3 to B3. When it is loaded though a drug diffusion mechanism, the syringe containing the oil is connected to the opening A3 and loaded oil into the main-channel A3 to B3 and discharged from B3. This oil loading process similarly discharges the remaining drug solution from this main-channel and isolates the microchambers in this main-channel A3 to B3 from each other. This process can be repeated for additional main-channels in the device. To summarize, he excess drug solutions are washed out from the main-channels using a biocompatible oil at a specific time-point (the so-called loading time), isolating every two adjacent microchambers from each other (FIG. 5D, Step-iii). This oil isolation step helps to avoid any drug, culture medium, or chemical indicator exchange between two consecutive microchambers, as well. Finally, the openings are blocked and the operator waits until the drugs distribute evenly into microchambers (FIG. 5D, Step-iv). The microfluidic device can then be placed into a water bath or incubator to thermally incubate the device for bacterial growth monitoring.

When the uniform drug distribution is obtained in the microchambers, this results in a wide C₅-C₁″ GCP in the EL-MVM² platform (note, C₅ and C₁″ are the minimum and maximum drug concentrations, respectively as shown in FIG. 5D, Step-iv). Moreover, the sub-concentration (C₅-C₁), (C₅′-C₁′), and (C₅″-C₁″) GCPs are connected as the C₁ (maximum concentration of low sub-concentration GCP) is equal to C₅′ (minimum concentration of intermediate sub-concentration GCP), and the same for C₁′ and C₅″.

### Example 3—EL-MVM² Platform Functionality for a Representative Drug

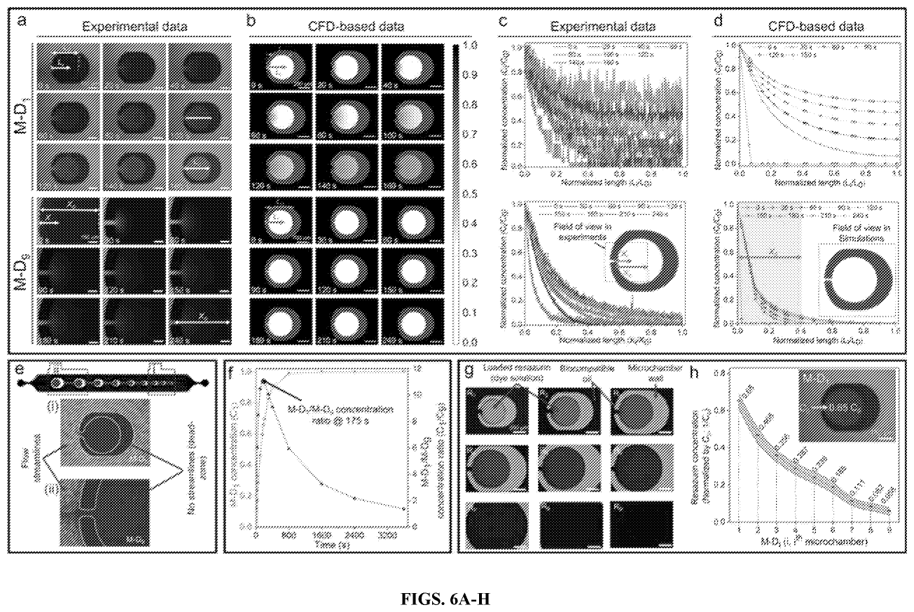

To study the kinetics of loading an antibiotic solution into microchambers, resazurin, a fluorescent dye, was used to fluorescently monitor the loading process. Resazurin is a small molecule with a size that falls within the range of antibiotics' molecular sizes. In this respect, microchambers M-D₁ and M-D₉ as the smallest and largest microchambers in each concentration sub-range were chosen and the time-lapse of the resazurin loading into these two microchambers was experimentally performed (FIG. 6A). For the microchamber M-D₁, the resazurin dye loading progress was monitored at different local position (L) along M-D₁ diameter (Lo). For microchamber M-D₉, the resazurin loading progress was monitored over the length Xo (note that Xo in experiment is not equal to M-D₉ diameter due to limits in the field of view during the microscopy imaging). The computational fluid dynamics (CFD) simulations were also performed for the M-D₁ and M-D₉ microchambers, representing the resazurin loading into the microchambers M-D₁ and M-D₉ (FIG. 6B). Moreover, FIG. 6C shows the experimental time-lapse concentration profiles along the screened lengths (Lo and Xo for microchambers M-D₁ and M-D₉, respectively), as obtained by converting the fluorescent intensities of resazurin emitted from microchambers M-D₁ and M-D₉ to gray-values using ImageJ software. As shown, the microchamber M-D₁ was close progressing to reach as 0.6 normalized concentration as short as ˜160 s while the microchamber M-D₉ was far from reaching this concentration within the same resazurin loading time. This is due to the larger volume of microchamber M-D₉ than M-D₁, as the volume ratio of M-D₉/M-D₁ is 12.5 (M-D₁ and M-D₉ diameters are 400 and 1400 μm, respectively).

The resazurin concentration profile changes over the microchambers M-D₁ and M-D₉ using CFD simulations was also screened (FIG. 6D). The resazurin concentration profiles obtained using CFD simulations helped to overcome the limitations associated with the imaging and the screening of the whole area of the microchamber M-D₉ using the experimental approach. The CFD simulation results for resazurin concentration profiles (FIG. 6D) excellently supported the experimental data (FIG. 6C).

Both the experimental and the CFD simulations were used to further confirm that the mass transport (resazurin or in a broader aspect, the antibiotics) into the microchambers only happens via the diffusion mechanism (FIG. 6E and FIG. 13, respectively). In this respect, a GFP-labeled E. coli 541-15 bacterial suspension was used to load into the EL-MVM² device. As shown in FIG. 6E, the streamlines obtained using the GFP-labeled E. coli trajectory movement well-confirmed formation of flow streamlines outside the microchambers, as well as, the dead-zone formed in the microchambers. This suggests that the mass transport was not through mass convection (via flow streamlines) in the microchambers, rather by diffusion as the main mechanism for resazurin loading. Using CFD simulations, as shown in FIG. 13, the same observation was confirmed as the dead-zones are formed in microchambers—i.e., no flow streamlines are observed in microchambers despite the flow streamlines' formation outside the microchambers.

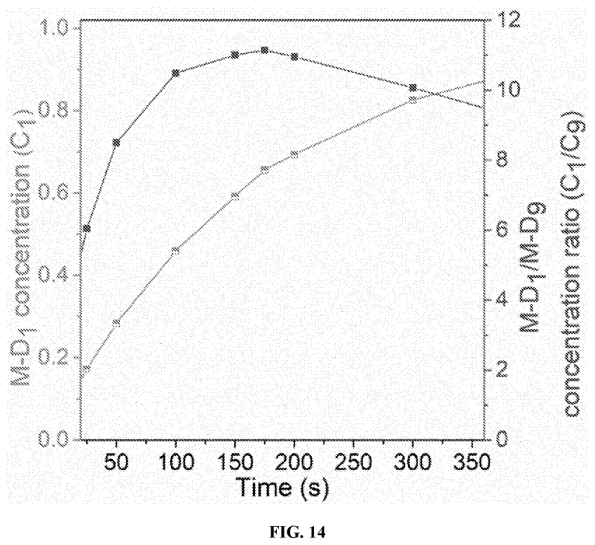

The resazurin concentrations was then measured in microchamber M-D₁ and the M-D₁/M-D₉ resazurin concentration ratio was calculated over the loading time using the CFD simulations. FIG. 6F shows the time-lapse mode of the resazurin concentration in the microchamber M-D₁ (concentrations normalized by C₀) and the (M-D₁/M-D₉) resazurin concentration ratio. The measurements were to find the maximum of difference in resazurin concentration between the microchambers M-D₁ (smallest) and M-D₉ (largest)—in each low, intermediate, and high subcategories. As shown in FIG. 6F and highlighted in FIG. 14, the maximum ratio (M-D₁/M-D₉) of resazurin concentrations was achieved at time-point t=175 s, when microchamber M-D₁ has not yet become saturated (i.e., normalized resazurin concentration in microchamber M-D₁ had not become equal to 1).

This time-point (t=175 s), found by CFD simulations to experimentally load the resazurin in EL-MVM² platform, was used to obtain a resazurin GCP (FIG. 6G). As shown, the resazurin fluorescent intensities (i.e., concentration) significantly decreased from the smallest microchamber (M-D₁) to the largest one (M-D₉), as hypothesized. The fluorescent intensities of each microchamber (n=5) were also converted to gray-values using ImageJ software and the microchambers concentrations were quantitatively calculated (FIG. 6H). As shown in FIG. 6H, a wide concentration range of antibiotics was produced—i.e., 11.2-fold difference as the M-D₁ concentration (0.65) divided by the M-D₉ concentration (0.058)—in any of low, intermediate, and high concentration sub-categories.

### Example 4—GCP Formation for Different Drugs in the EL-MVM² Platform

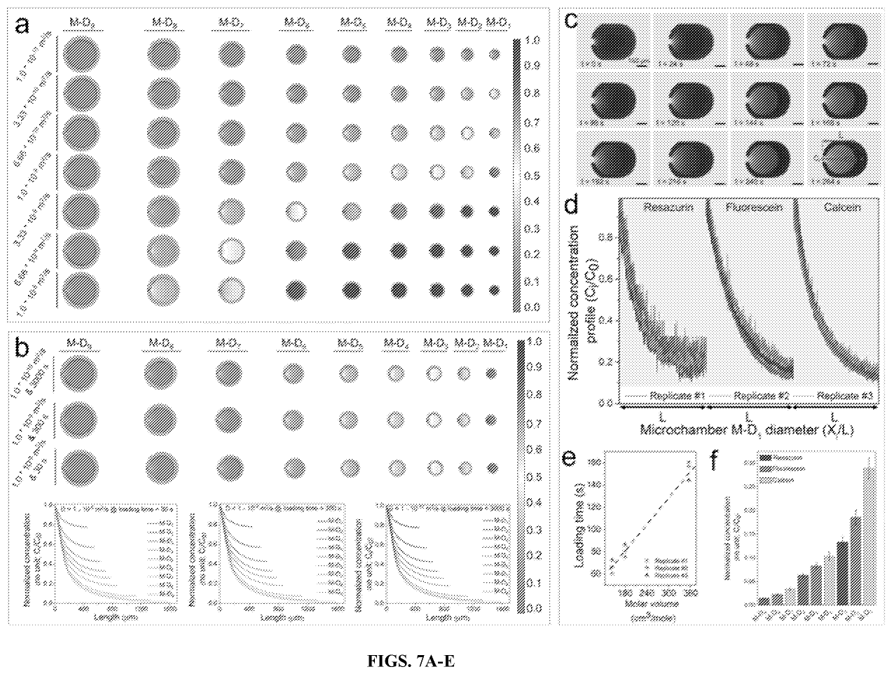

As the drug diffusion is the main mechanism for antibiotics' loading into microchambers, this may be an effective point for the formation of drugs' GCPs in the EL-MVM² platform. To further elaborate this point, the CFD simulations were used to study the antibiotics' GCPs in the microchambers M-D₁-M-D₉ in the EL-MVM² platform (FIG. 7A; diffusion coefficients represent a wide range of antibiotics). As can be seen in FIG. 7A, different GCPs were obtained for varies of antibiotics within the same loading timeframe (300 s). It was postulated that a drug with a higher diffusion coefficient—e.g., D=1×10⁻⁸ m²/s, which is correlated with smaller molecular size, can diffuse more readily into microchambers. Therefore, it can saturate the pre-loaded culture medium into microchambers within the same loading time, whereas larger volume molecules-lower diffusion coefficient-do not. This notion helped to adjust the loading time for drugs with different diffusion coefficients and obtain the same GCPs in the EL-MVM² platform, as shown in FIG. 7B. In this respect, CFD simulations were used to interrogate different loading times for three diffusion coefficients—D=1×10⁻¹⁰, 1×10⁻⁹, and 1×10⁻⁸ m²/s—to find the potential relationship between the diffusion coefficients and the loading times. It was found out that antibiotic diffusion coefficient and loading time function via a linear inverse relationship to obtain the same GCPs (i.e., GCP∝Fun. (D/loading time). In other words, antibiotics with higher diffusion coefficients require a shorter loading time to obtain the same GCP into microchambers M-D₁-M-D₉ in the EL-MVM² platform as antibiotics with smaller diffusion coefficients (FIG. 7B).

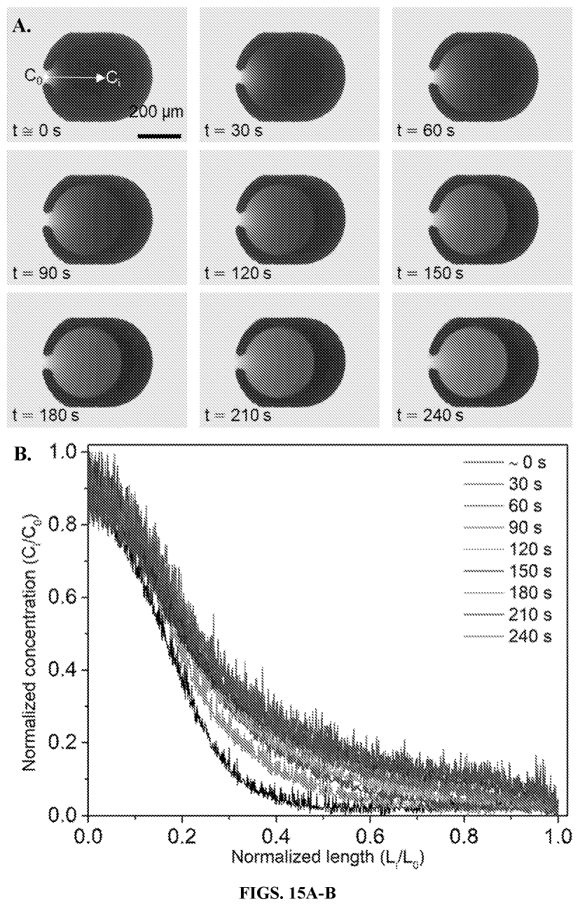

Given the fact that there is no extensive database for antibiotics' diffusion coefficients in the literature, and determining the diffusion coefficient of a targeted antibiotic requires the need to use complicated machines or tools (such as, NMR, see Azizi et al. “Biological Small-Molecule Assays Using Gradient-Based Microfluidics,” Biosens. Bioelectron. 178:113038 (2021), which is hereby incorporated by reference in its entirety) for obtaining diffusion coefficients of targeted antibiotics, it is difficult to achieve an accurate loading time without a diffusion coefficient for running the EL-MVM² platform. Thereby, an easily accessible parameter was found to obtain the antibiotics' loading time, emphasizing the easy-to-implement aspect of the EL-MVM² platform suitable as a candidate for AST clinical uses. To find this parameter, three fluorescent dyes (resazurin, fluorescein, and calcein) were chosen, as they also fell within the same range of molecular sizes as antibiotics, and their loading in the EL-MVM² platform was monitored. The loading kinetics of dyes into the microchamber M-D₁ are demonstrated for calcein (FIG. 7C), fluorescein (FIGS. 15A-B), and resazurin (previously shown in FIG. 6A). The dyes with concentration C₀ were loaded and the dye concentration over the length L equals to the microchamber diameter—as demonstrated in the last panel of FIG. 7C—was monitored. As shown in FIG. 7D, the normalized concentration (Cᵢ/C₀) profile for resazurin, fluorescein, and calcein was shown at time-points 60 s, 78 s, and 210 s, respectively. Using the loading kinetics of dyes into microchamber M-D₁ in the EL-MVM² platform (FIG. 7E), it was realized that they produce the same concentration profiles as the loading time followed a linear relationship with dyes' molar volumes (i.e., GCP∝Fun. (D/molar volume)). Then, resazurin, fluorescein, and calcein were loaded (using the loading times 60 s, 78 s, and 210 s, respectively) into the EL-MVM² platform and the same GCPs were obtained for them, as plotted together in a consecutive pattern in FIG. 7F. The graphs formed a continuous GCP with no breakage when combined, suggesting the individual GCPs (data not shown) were comparable. The suggested GCP∝Fun. (D/molar volume) relationship was also used to obtain the loading time for a wide range of antibiotics, mostly used in clinical diagnostics, as depicted in FIG. 16.

### Example 5—Antibiotic Homogenous Distribution in Microchambers

As the last step of the EL-MVM² operational protocol (FIG. 5D, step iv), the loaded antibiotic drug, isolated in each microchamber after oil washing step, should be distributed evenly inside of the microchambers to ensure every bacterial cell has the same exposure to antibiotic molecules. Logically, the culture medium loaded into microchambers M-D₁ (the smallest microchamber in any of low, intermediate, and high concentration ranges) are saturated faster than other microchambers in the same concentration range due to their smaller sizes. Then, the drug distribution time-limiting factor in each row would be microchamber M-D₉.

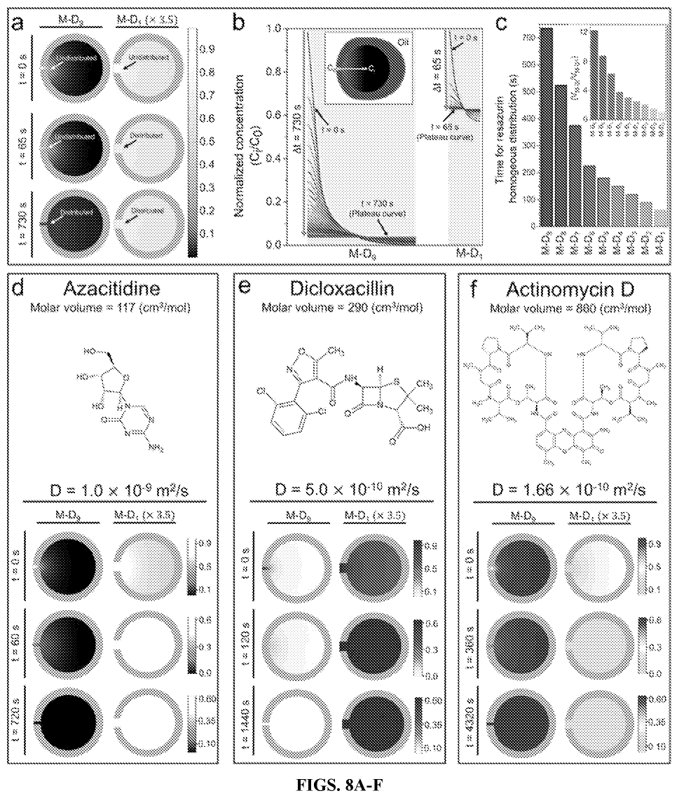

In this respect, microchambers M-D₁ and M-D₉ were chosen to study the timescales that the loaded resazurin was homogenously distributed. As shown in FIG. 8A, the CFD simulations showed that the resazurin homogenous distribution in microchambers M-D₁ (magnified by 3.5) and M-D₉ were obtained at incubation time-points 65 s and 735 s. This was also studied quantitatively in FIG. 8B, as the normalized concentration profiles moved from undistributed to distributed concentration profiles at time-points 65 s and 730 s for microchambers M-D₁ and M-D₉, respectively. The resazurin homogenous distribution times were also obtained for all microchambers M-D₁-M-D₉ to find the correlation between microchambers sizes and the homogenous distribution times (FIG. 8C). As shown in the inset of FIG. 8C, the time trend profile for resazurin homogenous distribution for microchambers M-D₁-M-D₉ (FIG. 8C) is a function of the M-D₁-based normalized volume of microchambers, M-Dᵢ (as defined by V_{M-Di}/V_{M-D1}).

In addition to resazurin (a non-drug fluorescent dye), the homogenous distribution of three representative antibiotics with the diffusion coefficients D=1.66×10⁻¹⁰, 5.0×10⁻¹⁰, and 1.0×10⁻⁹ m²/s (e.g., azacitidine, dicloxacillin, and actinomycin, respectively) were also studied, which represent a wide range of antibiotic drugs (FIGS. 8D-F). As can be seen in FIG. 8D, the antibiotics' homogenous distribution in microchambers M-D₁ and M-D₉ happened quickly especially for the small-molecule antibiotics such as azacitidine (˜700-800 s, or <15 min). For the larger antibiotics in FIGS. 8E-F, the antibiotics' homogenous distribution is a slower process (≤1 h); however, compared to the most AST assays which can take several hours, this drug homogenous distribution time is not significant.

### Example 6—AST for a Bacterial Species in the EL-MVM² Platform

To study the functionality of the EL-MVM² platform for an AST assay, GFP-labeled E. coli 541-15 was loaded into microchambers. The susceptibility/resistance outcome of this bacterial strain was examined to a testing antibiotic (gentamicin) and the MIC was found in case of the susceptibility outcome. The concentration of E. coli 541-15 bacterial suspension was equal to 1×10⁶ CFU/mL. The resazurin was also added to the bacterial suspension at a specific concentration (5 wt %). Resazurin helped to monitor the bacterial survival and growth through an irreversible resazurin-resorufin enzymatic reduction reaction (i.e., with increasing bacterial growth, the higher resazurin reduction results in greater fluorescent intensity) during an AST test (see Evans et al. “Quantitative Interpretation of Diffusion-Ordered NMR Spectra: Can We Rationalize Small Molecule Diffusion Coefficients?” Angew. Chem., Int. Ed. 52:3199-3202 (2013), which is hereby incorporated by reference in its entirety). Moreover, kanamycin was added at 50 μg/mL concentration in this specific experiment, as it helped avoid the GFP plasmid repulsion by E. coli 541-15 bacteria during the AST assay. Therefore, counting the number of this GFP-labeled bacteria would be the second approach to check the bacterial growth during this AST assay.

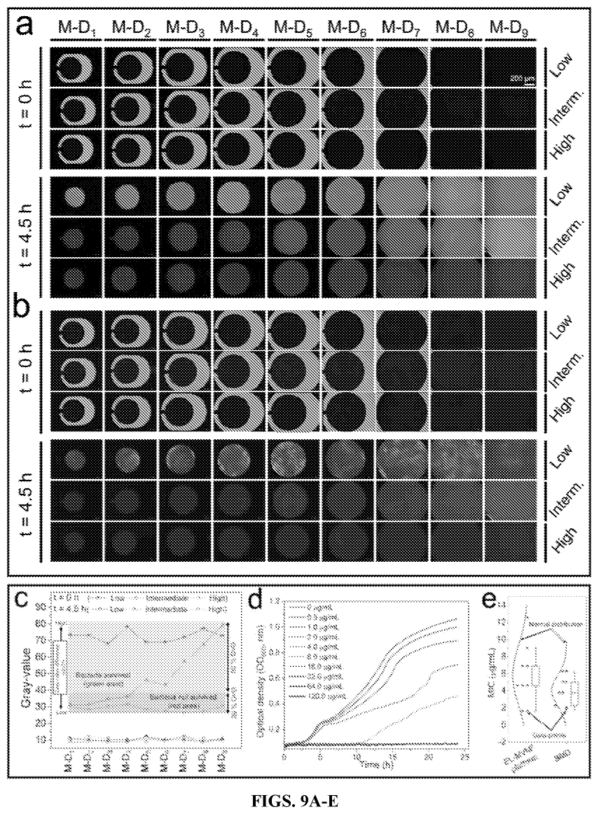

Gentamicin GCP were generated in the low (0.1-1.12 μg/mL), intermediate (1.12-12.54 μg/mL), and high (12.54-140 μg/mL) sub-GCPs. At t=0 h, regardless of at which sub-GCPs, the microchambers were monitored as they had the same resazurin-emitted fluorescent intensity (FIG. 9A, t=0 h). However, after incubation of the bacteria for 4.5 h at 37° C., the fluorescent intensities in the microchambers of the low concentration range were significantly higher than the high concentration range. The fluorescent intensity transition between high and low fluorescent intensities happened within the microchambers M-D₁-M-D₉ at intermediate sub-GCP (FIG. 9A, t=4.5 h). These results clearly indicate that the MIC at which the E. coli 541-15 is susceptible to the gentamicin, can be found in intermediate concentration range (i.e., 1.12-12.54 μg/mL).

To verify the E. coli 541-15-gentamicin MIC findings using resazurin-based bacterial growth metabolism, the GFP-labeled E. coli 541-15 growth was also monitored, as shown in FIG. 9B. During the 4.5 hours of incubation, E. coli 541-15 growth was recorded and imaged. E. coli 541-15 grew well in microchambers associated with low GCP range while it failed to grow in high GCP range. The turning point for E. coli 541-15, from being partially to totally inhibited, was in the intermediate concentration range (FIG. 9B). Thus, the monitoring of GFP-labeled bacterial growth confirmed the findings using resazurin-reduction by E. coli 541-15 bacterial metabolites (FIG. 9A and FIG. 9B, respectively).

The resazurin-emitted fluorescent intensities' changes during this AST assay were also converted to quantitatively measure the MIC precisely (FIG. 9C). As shown, the fluorescent intensities' transition happened around microchamber M-D₄ in intermediate concentration range. Note, the MIC associated with the microchamber with an 80% reduction in its gray-value relative to the average high and low gray values was determined. This criterion was similar to 80% reduction in optical bacterial cell density (OD_{600 nm}) used in the gold-standard BMD technique to determine the MIC (Palomino et al., “Resazurin Microtiter Assay Plate: Simple and Inexpensive Method for Detection of Drug Resistance in Mycobacterium Tuberculosis,” Antimicrob. Agents Chemother. 46:2720-2722 (2002), Otvos et al., “Broth Microdilution Antibacterial Assay of Peptides,” In Peptide Characterization and Application Protocols; Fields, G. B., Ed.” Humana Press: Totowa, NJ, pp. 309-320 (2007), and Waites et al., “Standardized Methods and Quality Control Limits for Agar and Broth Microdilution Susceptibility Testing of Mycoplasma Pneumoniae, Mycoplasma Hominis, and Ureaplasma Urealyticum,” J. Clin. Microbiol. 50:3542-3547 (2012), which are hereby incorporated by reference in their entirety). As a result, 5.53 μg/mL was found as the gentamicin MIC for E. coli 541-15 (normalized concentration=0.287 of the loaded gentamicin concentration in the intermediate range with C_{M-D1}=12.54 μg/mL). Moreover, the BMD technique was used (measuring the cell density of a bacterial suspension—OD_{600 nm}—versus the incubation time) to validate the EL-MVM² platform functionality with BMD (FIG. 9D). The value 5.00 μg/mL was obtained as the MIC for the E. coli 541-15/gentamicin pair using the BMD, which is in an excellent agreement with the EL-MVM² platform finding (i.e., 5.55 μg/mL). FIG. 9E also shows the nine replications of the AST assays for the E. coli 541-15/gentamicin pair using both the EL-MVM² platform and the BMD as there is close agreement between the EL-MVM² platform and the BMD technique.

### Example 7—EL-MVM² Platform for ASTs of Clinical Isolates

The developed EL-MVM² platform was tested for clinical bacterial isolates versus several antibiotics, which included a wide range of antibiotics' mechanisms of action. In this respect, nalidixic acid was chosen as it induces formation of cleavage complexes through inhibiting a subunit of DNA gyrase and topoisomerase IV (Vaudaux et al., “Underestimation of Vancomycin and Teicoplanin MICs by Broth Microdilution Leads to Underdetection of Glycopeptide-Intermediate Isolates of Staphylococcus Aureus,” Antimicrob. Agents Chemother. 54:3861-3870 (2010), which is hereby incorporated by reference in its entirety). Streptomycin was chosen as it binds to the 16S rRNA and S12 protein within the bacterial 30S ribosomal subunit (Chen et al., “DNA Gyrase and Topoisomerase Iv on the Bacterial Chromosome: Quinolone-Induced DNA Cleavage,” J. Mol. Biol. 258:627-637 (1996), which is hereby incorporated by reference in its entirety). Chloramphenicol prevents protein chain elongation by inhibiting the peptidyl transferase activity of the bacterial ribosome (Springer et al., “Mechanisms of Streptomycin Resistance: Selection Of Mutations in the 16S rRNA Gene Conferring Resistance,” Antimicrob. Agents Chemother. 45:2877-2884 (2001), which is hereby incorporated by reference in its entirety). Gentamicin is a broad-spectrum aminoglycoside antibiotic. Aminoglycosides work by binding to the bacterial 30S ribosomal subunit, causing misreading of t-RNA, leaving the bacterium unable to synthesize proteins vital to its growth (Marks et al., “Context-Specific Inhibition of Translation by Ribosomal Antibiotics Targeting the Peptidyl Transferase Center,” Proc. Natl. Acad. Sci. 113:12150-12155 (2016), which is hereby incorporated by reference in its entirety). Finally, to interfere the bacterial cell wall synthesis, ampicillin was picked to inhibit the enzyme transpeptidase activity (Vakulenko et al., “Versatility of Aminoglycosides and Prospects For Their Future,” Clin. Microbiol. Rev. 16:430-450. (2003), which is hereby incorporated by reference in its entirety).

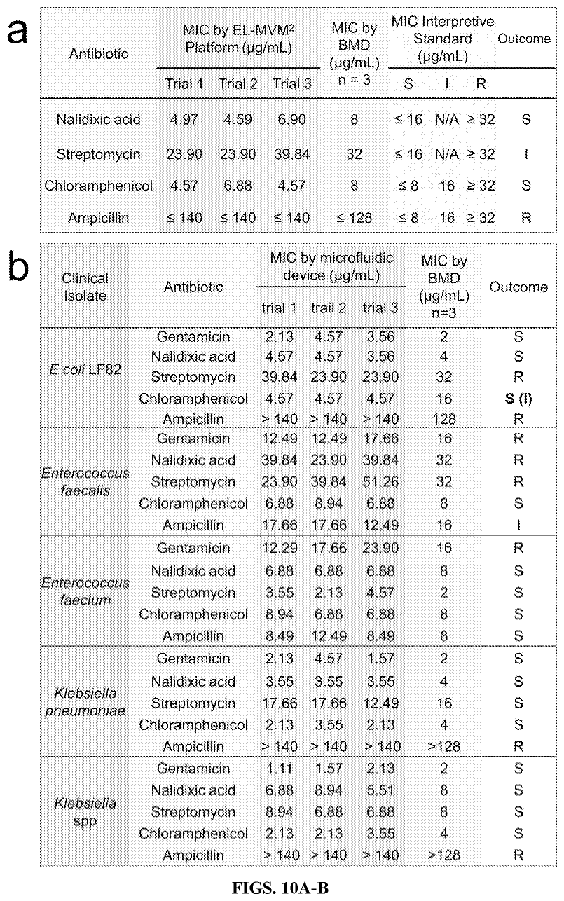

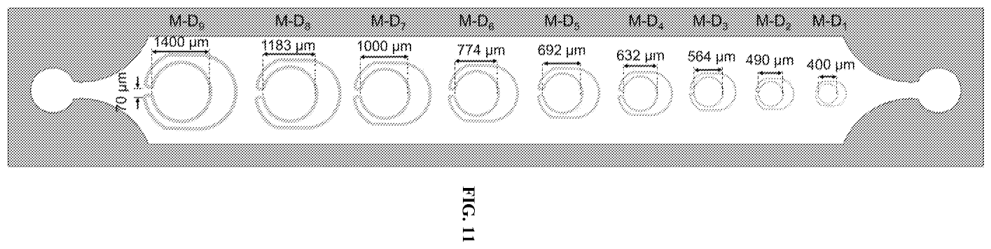

Different clinical bacterial isolates were chosen such as E. coli 541-15, E. coli LF82, Enterococcus faecalis, Enterococcus faecium, Klebsiella pneumoniae, and Klebsiella spp. Each bacterial species/antibiotic test was triplicated and the data are reported for E. coli 541-15 and other bacterial species (including E. coli LF82, Enterococcus faecalis, Enterococcus faecium, Klebsiella pneumoniae, and Klebsiella spp) in FIGS. 10A and 10B, respectively. FIG. 10A also includes the studying antibiotics' standard breakpoint concentrations for interpreting the obtained data using the EL-MVM² platform and gold-standard MBD (letters “S”, “R”, “I” represent the susceptible, resistance, and intermediate outcomes, respectively). These results, obtained using the EL-MVM² platform, show an excellent outcome accuracy as 29 correct predictions out of 30 bacteria/antibiotic testing pairs were correctly obtained. The only case that the EL-MVM² platform could not accurately predict its susceptibility/resistance pattern, was for the E. coli LF82/chloramphenicol pair, as shown in FIG. 10B. The criterion for a technology-based instrument applicable for AST is 95% accuracy, and EL-MVM² platform can well surpass this FDA-approval criterion (Teethaisong et al., “Synergistic Activity and Mechanism of Action of Stephania Suberosa Forman Extract and Ampicillin Combination Against Ampicillin-Resistant Staphylococcus Aureus,” J. Biomed. Sci. 21:90 (2014), which is hereby incorporated by reference in its entirety).

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A microfluidic circuit comprising:
an inlet port;
an outlet port;
a main channel fluidically connecting the inlet port and the outlet port; and
a series of microchambers of differing volumes disposed within the main channel, wherein each microchamber is individually fluidically connected to the main channel via individual microchamber openings.

2. The microfluidic circuit of claim 1, wherein the individual microchamber openings are positioned to face the outlet port.

3. The microfluidic circuit of claim 1 or claim 2, wherein each microchamber comprises an exterior wall and an interior wall, wherein the interior wall defines a volume of space constituting the microchamber.

4. The microfluidic circuit of any one of claims 1-3, wherein the exterior wall of the microchamber comprises an oval shape or an elongated oval shape and the interior wall of the microchamber defines a circular volume of space constituting the microchamber.

5. The microfluidic circuit of any one of claims 1-4, wherein the individual microchamber openings comprise an opening width of 40-100 μm, each interior wall of the microchambers has a diameter between 200-1500 μm, each inner microchamber space comprises a height of 40-100 μm, the inlet port comprises a diameter of 500-1500 μm, and the outlet port comprises a diameter of 500-1500 μm.

6. The microfluidic circuit of any one of claims 1-5, wherein each microchamber decreases in volume capacity as its position increases in distance from the inlet port.

7. The microfluidic circuit of any one of claims 1-6, wherein each interior wall of the microchamber decreases in diameter as a microchamber position increases in distance from the inlet port.

8. The microfluidic circuit of any one of claims 1-7, wherein the circuit comprises 2, 3, 4, 5, 6, 7, 8, 9, 10, 11, 12, 13, 14, 15, 16, 17, 18, 19, 20, 21, 22, 23, 24, or more than 24 microchambers.

9. The microfluidic circuit of any one of claims 1-8, wherein the main channel comprises a linear shape.

10. A microfluidic device comprising:
a support layer;
a substrate layer disposed on the support layer; and
one or more microfluidic circuits of any one of claims 1-9, wherein the one or more circuits are disposed within the substrate layer.

11. The microfluidic device of claim 10 comprising at least two microfluidic circuits, wherein the at least two microfluidic circuits are disposed within the substrate layer.

12. The microfluidic device of claim 11 further comprising:
a connecting channel connecting the at least two circuits.

13. The microfluidic device of claim 12, wherein the connecting channel is adjacent to the outlet ports.

14. The microfluidic device of any one of claims 10-13, wherein the support layer comprises glass.

15. The microfluidic device of any one of claims 10-14, wherein the substrate layer comprises polydimethylsiloxane (PDMS).

16. The microfluidic device of any one of claims 10-15 further comprising:
a top surface contiguous with the substrate layer.

17. The microfluidic device of any one of claims 10-15 further comprising:
a top surface contiguous with the substrate layer, wherein the top surface comprises polydimethylsiloxane (PDMS).

18. A method for performing an assay, said method comprising:
loading a first reagent solution into the inlet port of a microfluidic device of any one of claims 1-9;
loading a second reagent solution into the inlet port;
loading an isolating solution into the inlet port; and
detecting an interaction between the first reagent solution and the second reagent solution in one or more of the microchambers.

19. The method of claim 18, wherein the first reagent solution fills the microchambers.

20. The method of claim 18 or claim 19, wherein a portion of the second reagent solution diffuses into the microchambers.

21. The method of any one of claims 18-20, wherein a portion of the second reagent solution diffuses into the microchambers, thereby forming a concentration gradient of the second reagent solution within the microchambers from the inlet port to the outlet port.

22. The method of any one of claims 18-21, wherein the isolating solution prevents diffusion of the first reagent solution and second reagent solution from the microchambers.

23. The method of any one of claims 18-22, wherein the first reagent solution comprises a biological sample.

24. The method of claim 23, wherein the biological sample comprises a prokaryotic cell or prokaryotic cell component.

25. The method of claim 23, wherein the biological sample comprises a eukaryotic cell or a eukaryotic cell component.

26. The method of any one of claims 18-25-37, wherein the second reagent solution comprises an antimicrobial compound.

27. The method of claim 25, wherein the biological sample comprises a cancer cell.

28. The method of claim 27, wherein the second reagent solution comprises an anti-cancer agent.

29. The method of any one of claims 18-28, wherein the isolating solution comprises a biocompatible oil.

30. The method of any one of claims 18-29, wherein said detecting an interaction between the first reagent solution and the second reagent solution comprises detecting a fluorescent signal.

31. The method of any one of claims 18-30, wherein said detecting an interaction between the first reagent solution and the second reagent solution comprises detecting a colorimetric signal.
